(19) United States
(12) Patent Application Publication
(10) Pub. No.: US 2024/0054333 A1
(43) Pub. Date: Feb. 15, 2024

(54) PIECEWISE FUNCTIONAL FITTING OF SUBSTRATE PROFILES FOR PROCESS LEARNING

(71) Applicant: Applied Materials, Inc., Santa Clara, CA (US)

(72) Inventors: Bharath Ram Sundar, Chennai (IN); Samit Barai, Chennai (IN); Raman Krishnan Nurani, Chennai (IN); Anantha R. Sethuraman, Palo Alto, CA (US)

(21) Appl. No.: 17/884,462

(22) Filed: Aug. 9, 2022

(51) Int. Cl. G06N 3/08

(52) U.S. Cl. CPC G06N 3/08

(57) ABSTRACT

A method includes receiving, by a processing device, data indicative of a plurality of measurements of a profile of a substrate. The method further includes separating the data into a plurality of sets of data, a first set of the plurality of sets associated with a first region of the profile, and a second set of the plurality of sets associated with a second region of the profile. The method further includes fitting data of the first set to a first function to generate a first fit function. The first function is selected from a library of functions. The method further includes fitting data of the second set to a second function to generate a second fit function. The method further includes generating a piecewise functional fit of the profile of the substrate. The piecewise functional fit includes the first fit function and the second fit function.

### TECHNICAL FIELD

The present disclosure relates to methods associated with machine learning models used for assessment of manufactured devices, such as semiconductor devices. More particularly, the present disclosure relates to methods for generating and utilizing piecewise functional fits of profiles of substrates for process characterization and process learning.

### BACKGROUND

Products may be produced by performing one or more manufacturing processes using manufacturing equipment. For example, semiconductor manufacturing equipment may be used to produce substrates via semiconductor manufacturing processes. Products are to be produced with particular properties, suited for a target application. Machine learning models are used in various process control and predictive functions associated with manufacturing equipment. Machine learning models are trained using data associated with the manufacturing equipment. Measurements of products (e.g., manufactured devices) may be taken, which may enhance understanding of device function, failure, performance, may be used for metrology or inspection, or the like.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

In one aspect of the present disclosure, a method includes receiving, by a processing device, data indicative of a plurality of measurements of a profile of a substrate. The method further includes separating the data into a plurality of sets of data, a first set of the plurality of sets associated with a first region of the profile, and a second set of the plurality of sets associated with a second region of the profile. The method further includes fitting data of the first set to a first function to generate a first fit function. The first function is selected from a library of functions. The method further includes fitting data of the second set to a second function to generate a second fit function. The method further includes generating a piecewise functional fit of the profile of the substrate. The piecewise functional fit includes the first fit function and the second fit function.

In another aspect of the disclosure, a non-transitory machine readable storage medium stores instructions which, when executed, cause a processing device to perform operations. The operations include receiving data indicative of a plurality of measurements of a profile of a substrate. The operations further include separating the data indicative of the plurality of measurements into a plurality of sets of data. A first set of the plurality of sets is associated with a first region of the profile. A second set of the plurality of sets is associated with a second region of the profile. The operations further include fitting data of the first set to a first function to generate a first fit function. The first function is selected from a library of functions. The operations further include fitting data of the second set to a second function to generate a second fit function. The second function is selected from the library of functions. The second function is different from the first function. The operations further include generating a piecewise functional fit of the profile of the substrate. The piecewise functional fit includes the first fit function and the second fit function.

In another aspect of the disclosure, a system comprises memory and a processing device coupled to the memory. The processing device is configured to perform operations. The operations include receiving data indicative of a plurality of measurements of a profile of a substrate. The operations further include separating the data indicative of the plurality of measurements into a plurality of sets of data. A first set of the plurality of sets is associated with a first region of the profile. A second set of the plurality of sets is associated with a second region of the profile. The operations further include fitting data of the first set to a first function to generate a first fit function. The first function is selected from a library of functions. The operations further include fitting data of the second set to a second function to generate a second fit function. The second function is selected from the library of functions. The second function is different from the first function. The operations further include generating a piecewise functional fit of the profile of the substrate. The piecewise functional fit includes the first fit function and the second fit function.

### BRIEF DESCRIPTION OF THE DRAWINGS

The present disclosure is illustrated by way of example, and not by way of limitation in the figures of the accompanying drawings.

FIG. 1 is a block diagram illustrating an exemplary system architecture, according to some embodiments.

FIG. 2A depicts a block diagram of a system including an example data set generator for creating data sets for one or more supervised models, according to some embodiments.

FIG. 2B depicts a block diagram of an example data set generator for creating data sets for one or more unsupervised models, according to some embodiments.

FIG. 3 is a block diagram illustrating a system for generating output data, according to some embodiments.

FIG. 4A is a flow diagram of a method for generating a data set for a machine learning model, according to some embodiments.

FIG. 4B is a flow diagram of a method for generating a profile piecewise functional fit, according to some embodiments.

FIG. 5A is a block diagram of a substrate measurement generation system, according to some embodiments.

FIG. 5B depicts an example substrate and an example functional fit of a profile of the substrate, according to some embodiments.

FIG. 5C is a flow diagram of system components of a system for generating and utilized a piecewise functional fit of a substrate profile, according to some embodiments.

FIG. 6 is a block diagram illustrating a computer system, according to some embodiments.

### DETAILED DESCRIPTION

Described herein are technologies related to generating a functional description of a profile of a substrate. In some embodiments, technologies described herein are related to generating a piecewise functional description of a manufactured or simulated substrate. A profile of a substrate may be related to a shape of one or more features of the substrate. For example, a substrate may include one or more critical dimensions, e.g., related to the width of a hole, groove, or trench in the substrate. A profile of the substrate may represent a shape of the substrate, e.g., critical dimension as a function of depth. Technologies described herein may enable generation of a piecewise function that succinctly and accurately described the shape of a feature, a profile of a substrate, etc.

Manufacturing equipment is used to produce products, such as substrates (e.g., wafers, semiconductors). Manufacturing equipment may include a manufacturing or processing chamber to separate (e.g., isolate) the substrate from the ambient environment for processing. The properties of produced substrates are to meet target values to facilitate specific functionalities. Manufacturing parameters are selected to produce substrates that meet the target property values. Many manufacturing parameters (e.g., hardware parameters, process parameters, etc.) contribute to the properties of processed substrates. Manufacturing systems may control parameters by specifying a set point for a property value and receiving data from sensors disposed within the manufacturing chamber, and making adjustments to the manufacturing equipment until the sensor readings match the set point. Manufacturing systems may generate, produce, process, or manufacture substrates. Substrates may be analyzed (e.g., measured, tested, etc.) to predict performance (e.g., quality) of the substrates, assess quality of the manufacturing system/process, etc. One or more profiles (e.g., a cross section of a structure/feature of the substrate) of a substrate may be measured. For a hole in a substrate (e.g., a hole etched in a substrate), one or more critical dimensions may be measured. A critical dimension, as used herein, may be related to the width of a hole (e.g., width as measured perpendicular to a centerline of the hole), often as a function of depth (e.g., depth at which the width measurement line intersects the centerline). Many measurements of critical dimension may be taken at various depths of a hole. The measurements as a function of depth may describe a profile of the substrate.

A physics-based model may be utilized to generate a simulated substrate (e.g., a set of data predicting the properties, geometry, etc., of a substrate manufactured according to parameters provided to the physics-based model). The inputs to a physics-based model may be different from the inputs to a manufacturing system. For example, a manufacturing system may include set points for power supplied to various components, frequency of one or more radio frequency components, gas flow settings, etc. Physics-based model inputs may include etch rates, deposition rates, gas compositions, energy transfer, etc. The physics-based model may be configured to receive as input the one or more simulation inputs and generate as output a simulated substrate (e.g., predicted data indicative of geometry and/or properties of a substrate processed in accordance with the simulation inputs). The simulated substrate data may include data indicative of one or more profiles of the simulated substrate. The simulated substrate data may include one or more measurements of critical dimension.

A machine learning model may be utilized to generate a simulated substrate. The inputs to a machine learning model may be different from or the same as (or include one or more of each) inputs to a physics-based model and/or inputs to a manufacturing system. A machine learning model may receive as input manufacturing parameters (e.g., set points, inputs of a manufacturing system), conditions (e.g., physics-based simulation inputs), sensor data (e.g., as received by sensors associated with the manufacturing system), combinations thereof, or the like. A machine learning model may be configured to generate a simulated substrate, e.g., predicted data indicative of properties of a substrate. The simulated substrate data may include data indicative of one or more profiles of the simulated substrate. The simulated substrate data may include one or more measurements of critical dimension.

A profile of a substrate (e.g., a manufactured substrate, a simulated substrate, etc.) may be extracted. A profile may be expressed as a series of data points, a series of measurements, etc. For example, critical dimension may be expressed as a number of points each corresponding to a measurement at an associated depth. This may be used to generate a plot of critical dimension vs. depth. Other dimensions, geometry, profiles, etc., of the substrate may be expressed.

In conventional systems, a number of indicators may be extracted from the measurements of the profile to describe the profile. For example, the profile may be associated with a critical dimension of a substrate. A number of measures may be extracted from the profile, e.g., as an approximation of the profile. Extracted values may include, for example, a maximum value, a minimum value, a location of a maximum or minimum value (e.g., a depth at which a maximum critical dimension occurs), a value at a lowest or highest value of a domain, a slope between two points of the profile, or the like.

A point representation (e.g., critical dimensions vs. depth) of a substrate profile may have a number of disadvantages. Inputs to the substrate generating system (e.g., process knobs of a substrate manufacturing system, simulation knobs of a physics-based model, inputs of a machine learning model, etc.) may affect many points of a profile. It may be difficult in a pointwise description to isolate a physical (e.g., geometric effect) provided by any change in an input. It may further be difficult to generate a target profile, e.g., many points may be assigned target values, the target values may be correlated in a non-linear, non-obvious way, etc.

An indicator representation of a substrate profile may have a number of disadvantages. An indicator representation may not fully represent the profile, may not accurately represent the profile, may not represent all portions of the profile, etc. An indicator representation may be blind to one or more portions of the profile, e.g., profiles that differ in certain regions of the profile, differ in certain geometrical ways, differ by certain values, etc., may be represented similarly in an indicator representation.

Aspects of the present disclosure may address one or more of these shortcomings of conventional technologies. Aspects of the present disclosure may enable generation of a functional description of non-trivial features of one or more profiles of a substrate (e.g., manufactured substrate, simulated substrate, etc.). Measurements of a profile of a substrate may be provided to a fitting tool (e.g., a fitting software of a general-purpose computer, purpose-built hardware, etc.). For example, a series of data points each corresponding to a critical dimension measurement and an associated depth may be provided to the fitting tool. The fitting tool may generate a piecewise function describing the profile, e.g., a piecewise function describing critical dimension as a function of depth.

In some embodiments, a processing device (e.g., configured to perform operations of a profile fitting tool) may receive the measurements of the profile of the substrate. The data may be separated into portions (e.g., each portion may correspond to a physical region of the profile of the substrate). Each portion may be described by a function (e.g., fit to a function). The entire profile may be described as a piecewise collection of the functions describing the portions.

In some embodiments, one or more constraints may be applied to the fit functions of the regions, to the piecewise fit function, etc. For example, boundaries between portions of the profile data, corresponding to boundaries between regions of the substrate, may have enforced conditions. Enforced boundary conditions may include continuity (e.g., enforcing that the functions describing the adjacent portions of the profile data take the same value at the boundary within a threshold error). Enforced boundary conditions may include smoothness (e.g., enforcing that the first derivative of the functions describing the adjacent portions of the profile data take the same value at the boundary within a threshold error). Enforced boundary conditions may include higher order conditions (e.g., enforcing higher order derivatives of functions describing the adjacent portions of the profile data take the same value at the boundary within a threshold error), etc.

The functions used to fit each portion of the profile may be selected from a library. The selection may be made by a processing device (e.g., by the fitting tool). The selection may be made by a user. In some embodiments, the substrate may comprise a semiconductor device. In some embodiments, the substrate may comprises a semiconductor memory device.

Aspects of the present disclosure may provide technical advantages over conventional technology. In some embodiments, a complete, accurate (e.g., error such as summed square error within a target/threshold value) description of a profile of a substrate may be generated with a small number of parameters (e.g., fewer than the number of data points describing the profile). In some embodiments, parameters of the fit may have physical significance, e.g., a concavity (e.g., coefficient of a second-degree polynomial term) of a portion of a profile may have physical significance as describing an effective radius of curvature of a portion of the profile. Adjusting various inputs to a substrate generation system (e.g., manufacturing system, model, etc.) may result in a change to a profile that can be easily parsed, easily related from parameters to geometry, etc. Fitting the profile to a piecewise fit function may smooth and/or de-noise the profile measurement data.

In some embodiments, parameters of multiple profiles (e.g., fit coefficients) may be provided to a model (e.g., statistical model, clustering model, machine learning model) to generate additional information about the substrate profile space. In some embodiments, a model may generate data indicative of correlations between parameters, which may be easily associated with correlations between physical changes in substrate profile.

In some embodiments, profile parameters may be correlated with inputs to the substrate generation system (e.g., by providing inputs and parameters to train a machine learning model). In some embodiments, models may be developed that correlate input parameters to a substrate generation system to profile parameters of a substrate.

In some embodiments, a profile (e.g., a particular shape of profile) may be targeted. A substrate generation system may be operated to obtain the target profile. Utilizing technologies of the present disclosure may simplify this process, e.g., by correlating fit parameters to geometric characteristics of a substrate profile, by correlating input conditions to profile parameters, by providing verification of experimental design, etc.

Technologies of the present disclosure provide advantages in operating a substrate generation system over conventional methods. Designing a processing procedure to generate a target profile may be an expensive process, in terms of time, energy, material cost for experiments, disposal of defective products, cost of developing expertise in experimental design, etc. Designing a procedure to target a profile described by parameters (e.g., parameters with physical meaning) may reduce these costs.

Performing clustering on parameters of a profile fit may allow for a more thorough understanding of the available output space of a substrate generation system. For example, a target profile may be outside the output space accessible according to one or more constraints of the substrate generation system. Easily accessing information indicating such constraints may reduce time, materials, energy, etc., expended in experimental design, testing, or the like.

In an aspect of the present disclosure, a method includes receiving, by a processing device, data indicative of a set of measurements of a profile of a substrate. The method further includes separating, by the processing device, the data indicative of the set of measurements into a series of sets of data. The first set of the series of sets is associated with a first region of the profile. A second set of the series of sets is associated with a second region of the profile. The method further includes fitting data of the first set to a first function to generate a first fit function. The first fit function is selected from a library of function. The method further includes fitting data of the second set to a second function to generate a second fit function. The second function is selected from the library of functions. The second function is different from the first function. The method further includes generating a piecewise functional fit of the profile of the substrate. The piecewise functional fit includes the first fit function and the second fit function.

In another aspect of the present disclosure, a non-transitory machine-readable storage medium stores instructions. The instructions, when executed, cause a processing device to perform operations. The operations include receiving, by a processing device, data indicative of a set of measurements of a profile of a substrate. The operations further include separating, by the processing device, the data indicative of the set of measurements into a series of sets of data. The first set of the series of sets is associated with a first region of the profile. A second set of the series of sets is associated with a second region of the profile. The operations further include fitting data of the first set to a first function to generate a first fit function. The first fit function is selected from a library of function. The operations further include fitting data of the second set to a second function to generate a second fit function. The second function is selected from the library of functions. The second function is different from the first function. The operations further include generating a piecewise functional fit of the profile of the substrate. The piecewise functional fit includes the first fit function and the second fit function.

In another aspect of the present disclosure, a system comprises memory and a processing device coupled to the memory. The processing device is configured to receive data indicative of a set of measurements of a profile of a substrate. The processing device is further to separate the data indicative of the set of measurements into a series of sets of data. The first set of the series of sets is associated with a first region of the profile. A second set of the series of sets is associated with a second region of the profile. The processing device is further to fit data of the first set to a first function to generate a first fit function. The first fit function is selected from a library of function. The processing device is further to fit data of the second set to a second function to generate a second fit function. The second function is selected from the library of functions. The second function is different from the first function. The processing device is further to generate a piecewise functional fit of the profile of the substrate. The piecewise functional fit includes the first fit function and the second fit function.

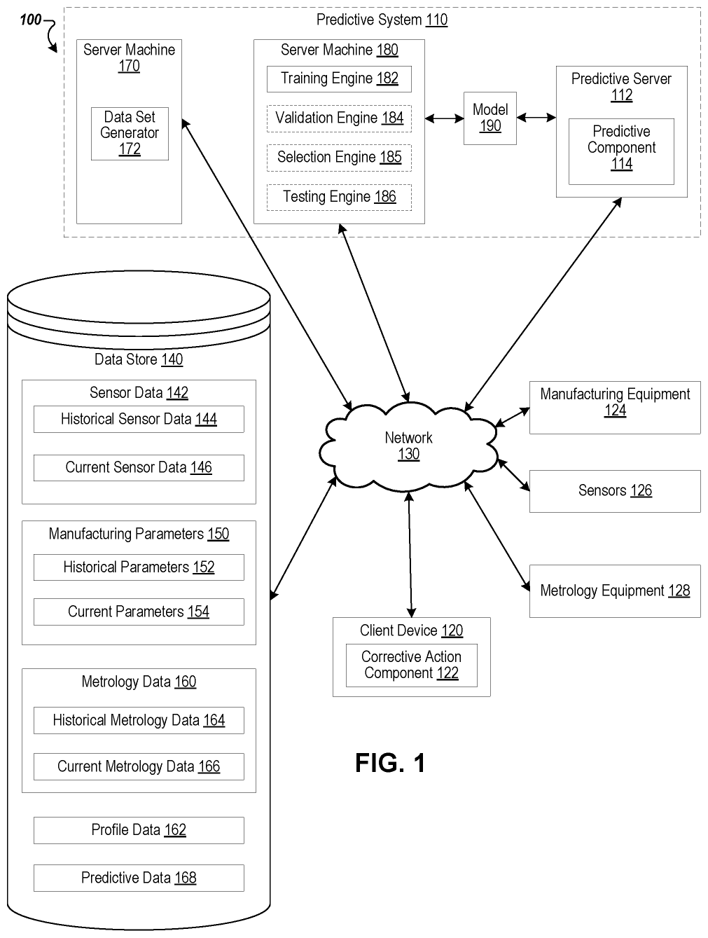

FIG. 1 is a block diagram illustrating an exemplary system 100 (exemplary system architecture), according to some embodiments. The system 100 includes a client device 120, manufacturing equipment 124, sensors 126, metrology equipment 128, predictive server 112, and data store 140. The predictive server 112 may be part of predictive system 110. Predictive system 110 may further include server machines 170 and 180.

Sensors 126 may provide sensor data 142 associated with manufacturing equipment 124 (e.g., associated with producing, by manufacturing equipment 124, corresponding products, such as substrates). Sensor data 142 may be used to ascertain equipment health and/or product health (e.g., product quality). Manufacturing equipment 124 may produce products following a recipe or performing runs over a period of time. In some embodiments, sensor data 142 may include values of one or more of optical sensor data, spectral data, temperature (e.g., heater temperature), spacing (SP), pressure, High Frequency Radio Frequency (HFRF), radio frequency (RF) match voltage, RF match current, RF match capacitor position, voltage of Electrostatic Chuck (ESC), actuator position, electrical current, flow, power, voltage, etc. Sensor data 142 may include historical sensor data 144 and current sensor data 146. Current sensor data 146 may be associated with a product currently being processed, a product recently processed, a number of recently processed products, etc. Current sensor data 146 may be used as input to a model, such as a trained machine learning model, e.g., to generate predictive data 168. Historical sensor data 144 may include data stored associated with previously produced products. Historical sensor data 144 may be used to train a model such as a machine learning model, e.g., model 190. Current sensor data 146 may be provided to the model, and the model may generate as output one or more predictions of properties of a substrate processed in conditions described by the current sensor data 146. The predictions of properties may include a prediction of critical dimension (CD), including a profile of the substrate. Historical sensor data 144 and/or current sensor data 146 may include attribute data, e.g., labels of manufacturing equipment ID or design, sensor ID, type, and/or location, label of a state of manufacturing equipment, such as a present fault, service lifetime, etc.

Sensor data 142 may be associated with or indicative of manufacturing parameters such as hardware parameters (e.g., hardware settings or installed components, e.g., size, type, etc.) of manufacturing equipment 124 or process parameters (e.g., heater settings, gas flow, etc.) of manufacturing equipment 124. Data associated with some hardware parameters and/or process parameters may, instead or additionally, be stored as manufacturing parameters 150, which may include historical manufacturing parameters 152 (e.g., associated with historical processing runs) and current manufacturing parameters 154. Manufacturing parameters 150 may be indicative of input settings to the manufacturing device (e.g., heater power, gas flow, etc.). Manufacturing parameters 150 may be provided to a model such as a physics-based model or a machine learning model as model input. Model output may include a simulated substrate, e.g., data representing one or more properties of a predicted substrate that would result from processing via the input parameters. Historical parameters 152 may be provided to train a model (e.g., a physics-based model, a machine learning model, etc.). Current parameters 154 may be provided to the model in order to obtain predicted properties of a substrate manufactured in accordance with the provided parameters. The predicted properties may include a profile of the simulated substrate, e.g., CD as a function of depth of a hole of the substrate.

Sensor data 142 and/or manufacturing parameters 150 may be provided while the manufacturing equipment 124 is performing manufacturing processes (e.g., equipment readings while processing products). Sensor data 142 may be different for each product (e.g., each substrate). Substrates (e.g., produced in accordance with current parameters 154, processed under conditions related to current sensor data 146, etc.) may have property values (film thickness, film strain, critical dimension, etc.) measured by metrology equipment 128, e.g., measured at a standalone metrology facility. Metrology data 160 may be a component of data store 140. Metrology data 160 may include historical metrology data 164 (e.g., metrology data associated with previously processed products). Metrology data 160 may include current metrology data 166 (e.g., associated with one or more current products). Metrology data may include one or more measurements of CD of a substrate. Metrology data may include a pointwise representation of a profile (e.g., a CD profile) of a substrate.

In some embodiments, metrology data 160 may be provided without use of a standalone metrology facility, e.g., in-situ metrology data (e.g., metrology or a proxy for metrology collected during processing), integrated metrology data (e.g., metrology or a proxy for metrology collected while a product is within a chamber or under vacuum, but not during processing operations), inline metrology data (e.g., data collected after a substrate is removed from vacuum), etc. Metrology data 160 may include current metrology data 166 (e.g., metrology data associated with a product currently or recently processed).

In some embodiments, sensor data 142, metrology data 160, or manufacturing parameters 150 may be processed (e.g., by the client device 120 and/or by the predictive server 112). Processing of the sensor data 142 may include generating features. In some embodiments, the features are a pattern in the sensor data 142, metrology data 160, and/or manufacturing parameters 150 (e.g., slope, width, height, peak, substrate profile, etc.) or a combination of values from the sensor data 142, metrology data, and/or manufacturing parameters (e.g., power derived from voltage and current, etc.). Sensor data 142 may include features and the features may be used by predictive component 114 for performing signal processing and/or for obtaining predictive data 168 for performance of a corrective action.

Each instance (e.g., set) of sensor data 142 may correspond to a product (e.g., a substrate), a set of manufacturing equipment, a type and/or design of substrate produced by manufacturing equipment, or the like. Each instance of metrology data 160 and manufacturing parameters 150 may likewise correspond to a product, a set of manufacturing equipment, a type of substrate produced by manufacturing equipment, or the like. The data store may further store information associating sets of different data types, e.g. information indicative that a set of sensor data, a set of metrology data, and a set of manufacturing parameters are all associated with the same product, manufacturing equipment, type of substrate, etc.

In some embodiments, a substrate is generated by one or more components of system 100. A physical substrate may be generated by manufacturing equipment 124. Properties of the physical substrate may be measured, quantified, etc., by metrology equipment 128, stored as metrology data 160, etc. A simulated substrate may be generated, for example by predictive system 110. A simulated substrate may be generated using sensor data 142, e.g., current sensor data 146 may be provided to a model, and output obtained from the model may be indicative of one or more properties of a substrate predicted to be generated based on the input conditions. A simulated substrate may be generated using manufacturing parameters 150, e.g., current parameters 154 may be provided to a model, and output obtained from the model may be indicative of one or more properties of a substrate predicted to be generated based on the input parameters. A simulated substrate may be generated based on simulation inputs, such as inputs describing processing parameters experienced by the substrate. Simulation inputs may include inputs that are not directly measured or controlled in a physical system, such as etch rate, deposition rate, rate taper, etc. Simulation inputs may include one or more parameters, e.g., some inputs may not have clear physical significance. Properties of simulated substrates may be stored, e.g., as metrology data 160. Simulated substrates may be generated by one or more physics-based models, one or more machine learning models, etc.

In some embodiments, predictive system 110 may generate predictive data 168 using supervised machine learning (e.g., predictive data 168 includes output from a machine learning model that was trained using labeled data, such as sensor data labeled with metrology data (e.g., which may include synthetic microscopy images generated according to embodiments herein, etc.). In some embodiments, predictive system 110 may generate predictive data 168 using unsupervised machine learning (e.g., predictive data 168 includes output from a machine learning model that was trained using unlabeled data, output may include clustering results, principle component analysis, anomaly detection, etc.). In some embodiments, predictive system 110 may generate predictive data 168 using semi-supervised learning (e.g., training data may include a mix of labeled and unlabeled data, etc.). In some embodiments, predictive system 110 may generate predictive data 168 using a physics-based model.

Predictive data 168 may include data associated with simulated substrates, e.g., predicted properties of substrates processed in processing conditions associated with simulation inputs. Predictive data 168 may include data associated with a profile of a substrate. Predictive data 168 may include functional parameters describing a substrate profile. Predictive data 168 may include output of a model predicting functional parameters describing a substrate profile. Predictive data 168 may include output of a model that receives, as input, one or more parameters of a functional description of a substrate profile and outputs one or more conditions (e.g., processing conditions, processing recipe operations, manufacturing equipment sensor measurements, etc.) that are predicted to be associated with generating a substrate with the input profile.

Client device 120, manufacturing equipment 124, sensors 126, metrology equipment 128, predictive server 112, data store 140, server machine 170, and server machine 180 may be coupled to each other via network 130 for generating predictive data 168 to perform corrective actions. In some embodiments, network 130 may provide access to cloud-based services. Operations performed by client device 120, predictive system 110, data store 140, etc., may be performed by virtual cloud-based devices.

In some embodiments, network 130 is a public network that provides client device 120 with access to the predictive server 112, data store 140, and other publicly available computing devices. In some embodiments, network 130 is a private network that provides client device 120 access to manufacturing equipment 124, sensors 126, metrology equipment 128, data store 140, and other privately available computing devices. Network 130 may include one or more Wide Area Networks (WANs), Local Area Networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

Client device 120 may include computing devices such as Personal Computers (PCs), laptops, mobile phones, smart phones, tablet computers, netbook computers, network connected televisions (“smart TV”), network-connected media players (e.g., Blu-ray player), a set-top-box, Over-the-Top (OTT) streaming devices, operator boxes, etc. Client device 120 may include a corrective action component 122. Corrective action component 122 may receive user input (e.g., via a Graphical User Interface (GUI) displayed via the client device 120) of an indication associated with manufacturing equipment 124. In some embodiments, corrective action component 122 transmits the indication to the predictive system 110, receives output (e.g., predictive data 168) from the predictive system 110, determines a corrective action based on the output, and causes the corrective action to be implemented. In some embodiments, corrective action component 122 obtains sensor data 142 (e.g., current sensor data 146) associated with manufacturing equipment 124 (e.g., from data store 140, etc.) and provides sensor data 142 (e.g., current sensor data 146) associated with the manufacturing equipment 124 to predictive system 110.

In some embodiments, predictive component 114 may facilitate generation of predictive data 168 (e.g., by providing input to one or more models 190). Corrective action component 122 may retrieve data from data store 140 and provide the data to predictive system 110 to generate predictive data 168. Sensor data 142 may be provided to predictive system 110 to generate as output one or more simulated substrates. Manufacturing parameters 150 may be provided to predictive system 110 to generate as output one or more simulated substrates. Substrate profile data 162 may be provided to predictive system 110 to generate a functional description of the profile (e.g., a piecewise functional fit of the profile). Profile fit parameters may be provided to predictive system 110 to generate a predicted procedure for generating a substrate with the input profile. Profile fit parameters may be provided to predictive system 110 for analysis, e.g., clustering analysis, parameter space analysis, etc.

In some embodiments, corrective action component 122 receives output from model 190, from predictive component 114, from predictive system 110, etc. Corrective action component 122 may store output data in data store 140, e.g., as predictive data 168, profile data 162, etc. Data output by predictive system 110 may be used as input for another component of predictive system 110. Client device 120 may store data that is used as input to one or more models 190. Client device 120 may store output data from one or more models 190. A component of predictive system 110 (e.g., predictive server 112, server machine 170, etc.) may retrieve data (e.g., from data store 140, from client device 120, etc.). Predictive server 112 may store output of one or more models 190, e.g., in data store 140, and client device 120 may retrieve the output data. Corrective action component 122 may perform one or more corrective actions based on data, e.g., retrieved from data store 140, received from predictive system 110, etc.

In some embodiments, corrective action component 122 receives an indication of a corrective action from the predictive system 110 and causes the corrective action to be implemented. Each client device 120 may include an operating system that allows users to one or more of generate, view, or edit data (e.g., indication associated with manufacturing equipment 124, corrective actions associated with manufacturing equipment 124, etc.).

In some embodiments, metrology data 160 (e.g., historical metrology data 164) corresponds to historical property data of products (e.g., products processed using manufacturing parameters associated with historical sensor data 144 and historical manufacturing parameters of manufacturing parameters 150) and predictive data 168 is associated with predicted property data (e.g., of products to be produced or that have been produced in conditions recorded by current sensor data 146 and/or current manufacturing parameters). In some embodiments, predictive data 168 is or includes predicted metrology data (e.g., virtual metrology data, simulated substrate data) of the products to be produced or that have been produced according to conditions recorded as current sensor data 146, current measurement data, current metrology data 166 and/or current parameters 154. In some embodiments, predictive data 168 is or includes an indication of any abnormalities (e.g., abnormal products, abnormal components, abnormal manufacturing equipment 124, abnormal energy usage, etc.) and optionally one or more causes of the abnormalities. In some embodiments, predictive data 168 is an indication of change over time or drift in some component of manufacturing equipment 124, sensors 126, metrology equipment 128, and the like. In some embodiments, predictive data 168 is an indication of an end of life of a component of manufacturing equipment 124, sensors 126, metrology equipment 128, or the like. In some embodiments, predictive data 168 is an indication of progress of a processing operation being performed, e.g., to be used for process control.

Performing manufacturing processes that result in defective products can be costly in time, energy, products, components, manufacturing equipment 124, the cost of identifying the defects and discarding the defective product, etc. By inputting sensor data 142 (e.g., manufacturing parameters that are being used or are to be used to manufacture a product) into predictive system 110, receiving output of predictive data 168, and performing a corrective action based on the predictive data 168, system 100 can have the technical advantage of avoiding the cost of producing, identifying, and discarding defective products. Products which are not predicted to meet performance thresholds may be identified and production halted, corrective actions performed, alerts sent to users, recipes updated, etc.

Performing manufacturing processes that result in failure of the components of the manufacturing equipment 124 can be costly in downtime, damage to products, damage to equipment, express ordering replacement components, etc. By inputting sensor data 142 (e.g., manufacturing parameters that are being used or are to be used to manufacture a product), metrology data, measurement data, etc., to predictive system 110, receiving output of predictive data 168, and performing corrective action (e.g., predicted operational maintenance, such as replacement, processing, cleaning, etc. of components) based on the predictive data 168, system 100 can have the technical advantage of avoiding the cost of one or more of unexpected component failure, unscheduled downtime, productivity loss, unexpected equipment failure, product scrap, or the like. Monitoring the performance over time of components, e.g. manufacturing equipment 124, sensors 126, metrology equipment 128, and the like, may provide indications of degrading components.

Manufacturing parameters may be suboptimal for producing product which may have costly results of increased resource (e.g., energy, coolant, gases, etc.) consumption, increased amount of time to produce the products, increased component failure, increased amounts of defective products, etc. By inputting indications of metrology into predictive system 110, receiving an output of predictive data 168, and performing (e.g., based on predictive data 168) a corrective action of updating manufacturing parameters (e.g., setting optimal manufacturing parameters), system 100 can have the technical advantage of using optimal manufacturing parameters (e.g., hardware parameters, process parameters, optimal design) to avoid costly results of suboptimal manufacturing parameters.

Recipe design and/or updating may be a costly process, including experimental design operations, manufacturing operations, and metrology operations, each iterated repeatedly until a target outcome is achieved. The target output may be a substrate including a target profile. By inputting metrology data 160 to predictive system 110, piecewise functional fits of profiles of substrates may be generated. Parameters of the fits may have physical significance, for example a coefficient of a quadratic polynomial term may indicate a sharpness of curvature of a portion of a substrate profile. Adjustments may be made to the fit parameters to generate an updated target profile. By providing the updated fit parameters to predictive system 110, and receiving as output predictive data 168 corresponding to predicted processing conditions, predicted manufacturing parameters, predicted simulation parameters, or the like that may result in the input profile, system 100 may reduce cost associated with recipe design and updating; cost associated with experimental procedures including material cost, energy cost, equipment usage, etc.; cost associated with disposing of experimental products; or the like.

Corrective actions may be associated with one or more of Computational Process Control (CPC), Statistical Process Control (SPC) (e.g., SPC on electronic components to determine process in control, SPC to predict useful lifespan of components, SPC to compare to a graph of 3-sigma, etc.), Advanced Process Control (APC), model-based process control, preventative operative maintenance, design optimization, updating of manufacturing parameters, updating manufacturing recipes, feedback control, machine learning modification, or the like.

In some embodiments, the corrective action includes providing an alert (e.g., an alarm to stop or not perform the manufacturing process if the predictive data 168 indicates a predicted abnormality, such as an abnormality of the product, a component, or manufacturing equipment 124). In some embodiments, a machine learning model is trained to monitor the progress of a processing run (e.g., monitor in-situ sensor data to predict if a manufacturing process has reached completion). In some embodiments, the machine learning model may send instructions to end a processing run when the model determines that the process is complete. In some embodiments, the corrective action includes providing feedback control (e.g., modifying a manufacturing parameter responsive to the predictive data 168 indicating a predicted abnormality). In some embodiments, performance of the corrective action includes causing updates to one or more manufacturing parameters. In some embodiments performance of a corrective action may include retraining a machine learning model associated with manufacturing equipment 124. In some embodiments, performance of a corrective action may include training a new model (e.g., machine learning model) associated with manufacturing equipment 124.

Manufacturing parameters 150 may include hardware parameters (e.g., information indicative of which components are installed in manufacturing equipment 124, indicative of component replacements, indicative of component age, indicative of software version or updates, etc.) and/or process parameters (e.g., temperature, pressure, flow, rate, electrical current, voltage, gas flow, lift speed, etc.). In some embodiments, the corrective action includes causing preventative operative maintenance (e.g., replace, process, clean, etc. components of the manufacturing equipment 124). In some embodiments, the corrective action includes causing design optimization (e.g., updating manufacturing parameters, manufacturing processes, manufacturing equipment 124, etc. for an optimized product). In some embodiments, the corrective action includes a updating a recipe (e.g., altering the timing of manufacturing subsystems entering an idle or active mode, altering set points of various property values, etc.).

Predictive server 112, server machine 170, and server machine 180 may each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc. Operations of predictive server 112, server machine 170, server machine 180, data store 140, etc., may be performed by a cloud computing service, cloud data storage service, etc.

Predictive server 112 may include a predictive component 114. In some embodiments, the predictive component 114 may receive current sensor data 146, and/or current manufacturing parameters (e.g., receive from the client device 120, retrieve from the data store 140) and generate output (e.g., predictive data 168) for performing corrective action associated with the manufacturing equipment 124 based on the current data. Predictive component 114 may receive current data (e.g., current metrology data 166) and generate as output a piecewise functional fit of a profile of a substrate. Predictive component 114 may receive a piecewise functional fit of a target profile of a substrate and produce as output an indication of conditions to generate a substrate with the target profile. In some embodiments, predictive data 168 may include one or more predicted dimension measurements of a processed product. In some embodiments, predictive component 114 may use one or more trained models 190 to determine the output based on current data. Models 190 may include machine learning models, physics-based models, statistical models, etc.

Manufacturing equipment 124 may be associated with one or more machine leaning models, e.g., model 190. Machine learning models associated with manufacturing equipment 124 may perform many tasks, including process control, classification, performance predictions, etc. Model 190 may be trained using data associated with manufacturing equipment 124 or products processed by manufacturing equipment 124, e.g., sensor data 142 (e.g., collected by sensors 126), manufacturing parameters 150 (e.g., associated with process control of manufacturing equipment 124), metrology data 160 (e.g., generated by metrology equipment 128), etc.

One type of machine learning model that may be used to perform some or all of the above tasks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g. classification outputs).

A recurrent neural network (RNN) is another type of machine learning model. A recurrent neural network model is designed to interpret a series of inputs where inputs are intrinsically related to one another, e.g., time trace data, sequential data, etc. Output of a perceptron of an RNN is fed back into the perceptron as input, to generate the next output.

Deep learning is a class of machine learning algorithms that use a cascade of multiple layers of nonlinear processing units for feature extraction and transformation. Each successive layer uses the output from the previous layer as input. Deep neural networks may learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. In an image recognition application, for example, the raw input may be a matrix of pixels; the first representational layer may abstract the pixels and encode edges; the second layer may compose and encode arrangements of edges; the third layer may encode higher level shapes (e.g., teeth, lips, gums, etc.); and the fourth layer may recognize a scanning role. Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs may be that of the network and may be the number of hidden layers plus one. For recurrent neural networks, in which a signal may propagate through a layer more than once, the CAP depth is potentially unlimited.

In some embodiments, predictive component 114 receives current sensor data 146, current metrology data 166 and/or current manufacturing parameters 154, performs signal processing to break down the current data into sets of current data, provides the sets of current data as input to a trained model 190, and obtains outputs indicative of predictive data 168 from the trained model 190. In some embodiments, predictive component 114 receives metrology data (e.g., predicted metrology data based on sensor data) of a substrate and provides the metrology data to trained model 190. For example, current sensor data 146 may include sensor data indicative of metrology (e.g., geometry, profile, etc.) of a substrate. In some embodiments, predictive data is indicative of metrology data (e.g., prediction of substrate quality). In some embodiments, predictive data is indicative of component health. In some embodiments, predictive data is indicative of processing progress (e.g., utilized to end a processing operation). In some embodiments, predictive data is indicative of a substrate generation procedure that is predicted to generate a substrate with target properties. Predictive data may be indicative of a procedure to generate a physical or simulated substrate with a target profile.

In some embodiments, the various models discussed in connection with model 190 (e.g., supervised machine learning model, unsupervised machine learning model, physics-based model, etc.) may be combined in one model (e.g., an ensemble model), or may be separate models.

Data may be passed back and forth between several distinct models included in model 190 and predictive component 114. In some embodiments, some or all of these operations may instead be performed by a different device, e.g., client device 120, server machine 170, server machine 180, etc. It will be understood by one of ordinary skill in the art that variations in data flow, which components perform which processes, which models are provided with which data, and the like are within the scope of this disclosure.

Data store 140 may be a memory (e.g., random access memory), a drive (e.g., a hard drive, a flash drive), a database system, a cloud-accessible memory system, or another type of component or device capable of storing data. Data store 140 may include multiple storage components (e.g., multiple drives or multiple databases) that may span multiple computing devices (e.g., multiple server computers). The data store 140 may store sensor data 142, manufacturing parameters 150, metrology data 160, synthetic data 162, and predictive data 168.

Sensor data 142 may include historical sensor data 144 and current sensor data 146. Sensor data may include sensor data time traces over the duration of manufacturing processes, associations of data with physical sensors, pre-processed data, such as averages and composite data, and data indicative of sensor performance over time (i.e., many manufacturing processes). Manufacturing parameters 150 and metrology data 160 may contain similar features, e.g., historical metrology data 164 and current metrology data 166. Historical sensor data 144, historical metrology data 166, and historical manufacturing parameters may be historical data (e.g., at least a portion of these data may be used for training one or more models 190). Current sensor data 146, current metrology data 166, may be current data (e.g., at least a portion to be input into learning model 190, subsequent to the historical data) for which predictive data 168 is to be generated (e.g., for performing corrective actions). Profile data 162 may include measurement of profiles of physical substrates, fit parameters of physical substrates, profile data of simulated substrates, fit parameters of simulated substrates, target profiles, etc.

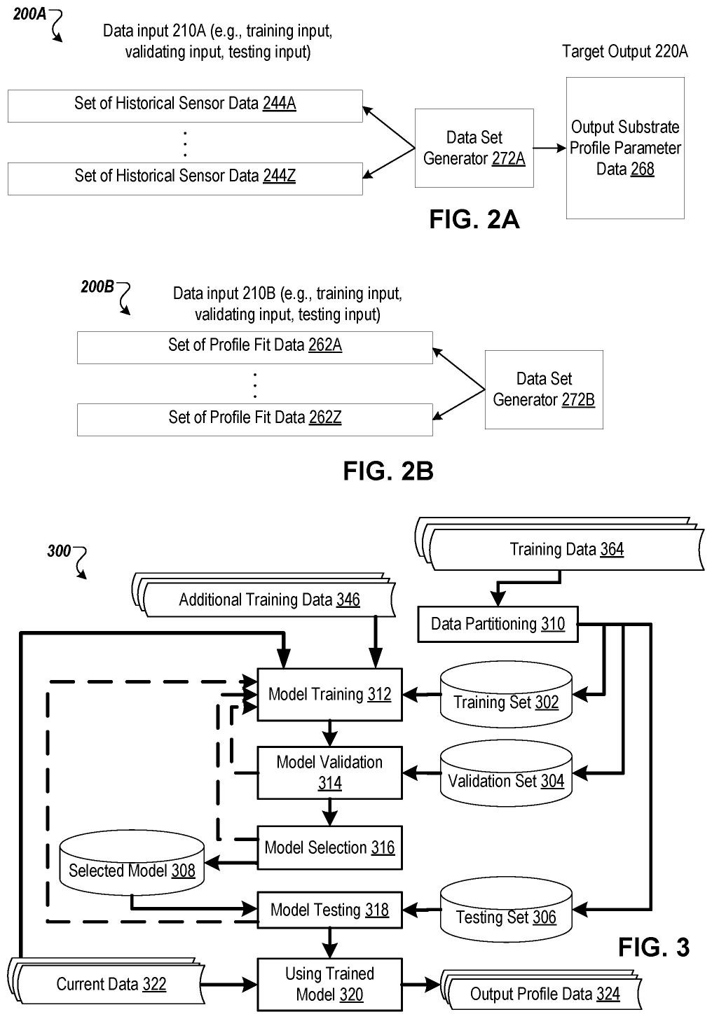

In some embodiments, predictive system 110 further includes server machine 170 and server machine 180. Server machine 170 includes a data set generator 172 that is capable of generating data sets (e.g., a set of data inputs and a set of target outputs) to train, validate, and/or test model(s) 190, including one or more machine learning models. Some operations of data set generator 172 are described in detail below with respect to FIGS. 2A-B and 4A. In some embodiments, data set generator 172 may partition the historical data (e.g., historical sensor data 144, historical manufacturing parameters, historical metrology data 164) into a training set (e.g., sixty percent of the historical data), a validating set (e.g., twenty percent of the historical data), and a testing set (e.g., twenty percent of the historical data).

In some embodiments, predictive system 110 (e.g., via predictive component 114) generates multiple sets of features. For example a first set of features may correspond to a first set of types of sensor data (e.g., from a first set of sensors, first combination of values from first set of sensors, first patterns in the values from the first set of sensors) that correspond to each of the data sets (e.g., training set, validation set, and testing set) and a second set of features may correspond to a second set of types of sensor data (e.g., from a second set of sensors different from the first set of sensors, second combination of values different from the first combination, second patterns different from the first patterns) that correspond to each of the data sets.

In some embodiments, machine learning model 190 is provided historical data as training data. The historical sensor data may be or include microscopy image data in some embodiments. The type of data provided will vary depending on the intended use of the machine learning model. For example, a machine learning model may be trained by providing the model with historical sensor data 144 as training input and corresponding metrology data 160 as target output. In some embodiments, a large volume of data is used to train model 190, e.g., sensor and metrology data of hundreds of substrates may be used.

Server machine 180 includes a training engine 182, a validation engine 184, selection engine 185, and/or a testing engine 186. An engine (e.g., training engine 182, a validation engine 184, selection engine 185, and a testing engine 186) may refer to hardware (e.g., circuitry, dedicated logic, programmable logic, microcode, processing device, etc.), software (such as instructions run on a processing device, a general purpose computer system, or a dedicated machine), firmware, microcode, or a combination thereof. The training engine 182 may be capable of training a model 190 and/or synthetic data generator 174 using one or more sets of features associated with the training set from data set generator 172. The training engine 182 may generate multiple trained models 190, where each trained model 190 corresponds to a distinct set of features of the training set (e.g., sensor data from a distinct set of sensors). For example, a first trained model may have been trained using all features (e.g., X1-X5), a second trained model may have been trained using a first subset of the features (e.g., X1, X2, X4), and a third trained model may have been trained using a second subset of the features (e.g., X1, X3, X4, and X5) that may partially overlap the first subset of features. Data set generator 172 may receive the output of a trained model (e.g., predictive data 168, profile data 162, etc.), collect that data into training, validation, and testing data sets, and use the data sets to train a second model (e.g., a machine learning model configured to output predictive data, corrective actions, etc.).

Validation engine 184 may be capable of validating a trained model 190 using a corresponding set of features of the validation set from data set generator 172. For example, a first trained machine learning model 190 that was trained using a first set of features of the training set may be validated using the first set of features of the validation set. The validation engine 184 may determine an accuracy of each of the trained models 190 based on the corresponding sets of features of the validation set. Validation engine 184 may discard trained models 190 that have an accuracy that does not meet a threshold accuracy. In some embodiments, selection engine 185 may be capable of selecting one or more trained models 190 that have an accuracy that meets a threshold accuracy. In some embodiments, selection engine 185 may be capable of selecting the trained model 190 that has the highest accuracy of the trained models 190.

Testing engine 186 may be capable of testing a trained model 190 using a corresponding set of features of a testing set from data set generator 172. For example, a first trained machine learning model 190 that was trained using a first set of features of the training set may be tested using the first set of features of the testing set. Testing engine 186 may determine a trained model 190 that has the highest accuracy of all of the trained models based on the testing sets.

In the case of a machine learning model, model 190 may refer to the model artifact that is created by training engine 182 using a training set that includes data inputs and corresponding target outputs (correct answers for respective training inputs). Patterns in the data sets can be found that map the data input to the target output (the correct answer), and machine learning model 190 is provided mappings that capture these patterns. The machine learning model 190 may use one or more of Support Vector Machine (SVM), Radial Basis Function (RBF), clustering, supervised machine learning, semi-supervised machine learning, unsupervised machine learning, k-Nearest Neighbor algorithm (k-NN), linear regression, random forest, neural network (e.g., artificial neural network, recurrent neural network), etc.

Predictive component 114 may provide current data to model 190 and may run model 190 on the input to obtain one or more outputs. For example, predictive component 114 may provide current sensor data 146 to model 190 and may run model 190 on the input to obtain one or more outputs. Predictive component 114 may be capable of determining (e.g., extracting) predictive data 168 from the output of model 190. Predictive component 114 may determine (e.g., extract) confidence data from the output that indicates a level of confidence that predictive data 168 is an accurate predictor of a process associated with the input data for products produced or to be produced using the manufacturing equipment 124 at the current sensor data 146 and/or current manufacturing parameters. Predictive component 114 or corrective action component 122 may use the confidence data to decide whether to cause a corrective action associated with the manufacturing equipment 124 based on predictive data 168.

The confidence data may include or indicate a level of confidence that the predictive data 168 is an accurate prediction for products or components associated with at least a portion of the input data. In one example, the level of confidence is a real number between 0 and 1 inclusive, where 0 indicates no confidence that the predictive data 168 is an accurate prediction for products processed according to input data or component health of components of manufacturing equipment 124 and 1 indicates absolute confidence that the predictive data 168 accurately predicts properties of products processed according to input data or component health of components of manufacturing equipment 124. Responsive to the confidence data indicating a level of confidence below a threshold level for a predetermined number of instances (e.g., percentage of instances, frequency of instances, total number of instances, etc.) predictive component 114 may cause trained model 190 to be re-trained (e.g., based on current sensor data 146, current manufacturing parameters, etc.). In some embodiments, retraining may include generating one or more data sets (e.g., via data set generator 172) utilizing historical data and/or simulated data.

For purpose of illustration, rather than limitation, aspects of the disclosure describe the training of one or more machine learning models 190 using historical data (e.g., historical sensor data 144, historical manufacturing parameters) and synthetic data 162 and inputting current data (e.g., current sensor data 146, current manufacturing parameters, and current metrology data) into the one or more trained machine learning models to determine predictive data 168. In other embodiments, a heuristic model, physics-based model, or rule-based model is used to determine predictive data 168 (e.g., without using a trained machine learning model). In some embodiments, such models may be trained using historical and/or simulated data. In some embodiments, these models may be retrained utilizing a combination of true historical data and simulated data. Predictive component 114 may monitor historical sensor data 144, historical manufacturing parameters, and metrology data 160. Any of the information described with respect to data inputs 210A-B of FIGS. 2A-B may be monitored or otherwise used in the heuristic, physics-based, or rule-based model.

In some embodiments, the functions of client device 120, predictive server 112, server machine 170, and server machine 180 may be provided by a fewer number of machines. For example, in some embodiments server machines 170 and 180 may be integrated into a single machine, while in some other embodiments, server machine 170, server machine 180, and predictive server 112 may be integrated into a single machine. In some embodiments, client device 120 and predictive server 112 may be integrated into a single machine. In some embodiments, functions of client device 120, predictive server 112, server machine 170, server machine 180, and data store 140 may be performed by a cloud-based service.

In general, functions described in one embodiment as being performed by client device 120, predictive server 112, server machine 170, and server machine 180 can also be performed on predictive server 112 in other embodiments, if appropriate. In addition, the functionality attributed to a particular component can be performed by different or multiple components operating together. For example, in some embodiments, the predictive server 112 may determine the corrective action based on the predictive data 168. In another example, client device 120 may determine the predictive data 168 based on output from the trained machine learning model.

In addition, the functions of a particular component can be performed by different or multiple components operating together. One or more of the predictive server 112, server machine 170, or server machine 180 may be accessed as a service provided to other systems or devices through appropriate application programming interfaces (API).

In embodiments, a “user” may be represented as a single individual. However, other embodiments of the disclosure encompass a “user” being an entity controlled by a plurality of users and/or an automated source. For example, a set of individual users federated as a group of administrators may be considered a “user.”

Embodiments of the disclosure may be applied to data quality evaluation, feature enhancement, model evaluation, Virtual Metrology (VM), Predictive Maintenance (PdM), limit optimization, process control, or the like.

FIGS. 2A-B depict block diagrams of example data set generators 272A-B (e.g., data set generator 172 of FIG. 1) to create data sets for training, testing, validating, etc. a model (e.g., model 190 of FIG. 1), according to some embodiments. Each data set generator 272 may be part of server machine 170 of FIG. 1. In some embodiments, several models associated with manufacturing equipment 124 may be trained, used, and maintained (e.g., within a manufacturing facility). Each model may be associated with one data set generators 272, multiple models may share a data set generator 272, etc. Data set generators 272A-B may be used to generate data sets for machine learning models, statistical models, physics-based models, etc.

FIG. 2A depicts a system 200A including data set generator 272A for creating data sets for one or more models (e.g., model 190 of FIG. 1). Data set generator 272A may create data sets (e.g., data input 210A, target output 220A) using historical data. Historical data may include simulated data, e.g., metrology data of simulated substrates. In some embodiments, a data set generator similar to data set generator 272A may be utilized to train an unsupervised machine learning model, e.g., target output 220A may not be generated by data set generator 272A.

Data set generator 272A may generate data sets to train, test, and validate a model. In some embodiments, data set generator 272A may generate data sets for a machine learning model. In some embodiments, data set generator 272A may generate data sets for training, testing, and/or validating a model configured to generate synthetic (e.g., digital or virtual) substrates. Data set generator 272A may generate sets of historical sensor data 244A-244Z as data input 210A for a machine learning model. The machine learning model may be provided with sets of historical sensor data 244A through 244Z as data input 210A. The machine learning model may be configured to receive sensor data as data input and generate profile parameters indicative of properties of a simulated substrate as model output.

In some embodiments, data set generator 272A may generate sets of target output 220A for a machine learning model. Target output 220A may include output substrate profile parameter data 268. Sets of target output 220A may be associated with sets of data input 210A. For example, a set of target output 220A may describe a profile of a substrate processed in conditions described by a corresponding set of data input 210A. The machine learning model may be provided with target output 220A for training, validating, testing, etc., the machine learning model.

A data set generator similar to data set generator 272A may be utilized to generate data sets for models with a range of functions. A data set generator may generate data sets for a model configured to generate simulated substrates (e.g., configured to generate data indicative of properties of simulated substrates). A data set generator may generate sets of data including sensor data, manufacturing parameters, simulation parameters, etc., as data input 210A and sets of data describing substrate properties as target output 220A for such a model.

A data set generator may generate data sets for a model configured to generate a profile functional fit from substrate profile data. The data set generator may generate sets of data as data input 210A including substrate profiles, e.g., collections of data points/measurements describing a substrate profile. The data set generator may generate sets of data as target output 220A including classification of functions to use to fit one or more portions of the profile (e.g., selected from a library of functions), fit parameters, boundaries between regions described by different fit parameters, boundary conditions between regions, etc. Target output 220A may include human labeled data, machine-labeled data (e.g., a best fit found by a processing device by searching through an available data space of fit functions, parameters, boundary locations, boundary conditions, etc.), or the like.

A data set generator may generate data sets for a model configured to generate parameters of a profile functional fit from substrate generation data. The data set generator may generate sets of data as data input 210A including data associated with substrate generation. The substrate generation data may include data associated with generation of physical substrates and/or simulated substrates. The substrate generation data may include sensor data associated with substrate manufacturing, substrate manufacturing parameters, simulation inputs, etc. The data set generator may generate sets of data as target output 220A including functional fit parameters of a substrate profile. Target output 220A may include classifications of functions used in the fit (e.g., selected from a library of functions), fit parameters, boundary locations between fit regions, boundary constraints/conditions, etc.

A data set generator may generate data sets for a model configured to generate substrate generation inputs from a substrate profile. The substrate profile may include data points, measurements, profile functional fit parameters, etc. The data set generator may generate sets of data as data input 210A including sets of substrate profile data. The data set generator may generate sets of data as target output 220A including substrate generation data. Substrate generation data may include data associated with generation of simulated or physical substrates. Substrate generation data may include sensor data, manufacturing parameters, simulation inputs, etc.

In some embodiments, data set generator 272A generates a data set (e.g., training set, validating set, testing set) that includes one or more data inputs 210A (e.g., training input, validating input, testing input). Data inputs 210A may be provided to training engine 182, validating engine 184, or testing engine 186. The data set may be used to train, validate, or test the model (e.g., model 190 of FIG. 1).

In some embodiments, data input 210A may include one or more sets of data. As an example, system 200A may produce sets of sensor data that may include one or more of sensor data from one or more types of sensors, combinations of sensor data from one or more types of sensors, patterns from sensor data from one or more types of sensors, and/or synthetic versions thereof. Similar subsets of data may be generated for machine learning models configured to receive as input different data.

In some embodiments, data set generator 272A may generate a first data input corresponding to a first set of historical sensor data 244A to train, validate, or test a first machine learning model. Data set generator 272A may generate a second data input corresponding to a second set of historical sensor data 244B to train, validate, or test a second machine learning model.

In some embodiments, data set generator 272A generates a data set (e.g., training set, validating set, testing set) that includes one or more data inputs 210A (e.g., training input, validating input, testing input) and may include one or more target outputs 220A that correspond to the data inputs 210A. The data set may also include mapping data that maps the data inputs 210A to the target outputs 220A. Data inputs 210A may also be referred to as “features,” “attributes,” or “information.” In some embodiments, data set generator 272A may provide the data set to training engine 182, validating engine 184, or testing engine 186, where the data set is used to train, validate, or test the machine learning model (e.g., one or more of the machine learning models that are included in model 190, ensemble model 190, etc.).

In some embodiments, a data set generator such as data set generator 272A may be utilized to generate data sets for one or more models that are not machine learning models. For example, the data set generator may be utilized to generate data sets for a physics-based model. The data set generator may generate data sets for a physics-based model configured to generate simulated substrates. The data set generator may generate data input 210A and/or target output 220A for a model that is not a machine learning model. The physics-based model may utilize the data sets generated by the data set generator to assign and/or adjust values of one or more parameters defining the relationship between inputs to the physics-based model and output from the physics-based model.

FIG. 2B depicts a block diagram of an example data set generator 272B for creating data sets for an unsupervised model configured to analyze clustering of input data, according to some embodiments. System 200B containing data set generator 272B (e.g., data set generator 172 of FIG. 1) creates data sets for one or more machine learning models (e.g., model 190 of FIG. 1). Data set generator 272B may create data sets (e.g., data input 210B) using historical data. Example data set generator 272B is configured to generate data sets for a machine learning model configured to take as input functional profile fit parameters and generate as output data indicative of fit parameter clustering. Analogous data set generators (or analogous operations of data set generator 272B) may be utilized for machine learning models configured to perform different functions, e.g., a machine learning model configured to receive as input sensor data and predicted metrology data, a machine learning model configured to receive as input target metrology data (e.g., a target microscopy image) and produce as output estimated conditions or processing operation recipes that may generate a device matching the input target data, etc. Data set generator 272B may share one or more features and/or functions with data set generator 272A.

Data set generator 272B may generate data sets to train, test, and validate a model. The model may be a machine learning model, a physics-based model, a statistical model, etc. The model may be provided with sets of profile fit data 262A-262Z (e.g., output from a model trained using data sets from data set generator 272A, etc.) as data input 210B. The machine learning model may include two or more separate models (e.g., the machine learning model may be an ensemble model). The machine learning model may be configured to generate output data indicating patterns, clustering, correlations, outlier data, anomalous data detection, etc., in profile fit parameters.

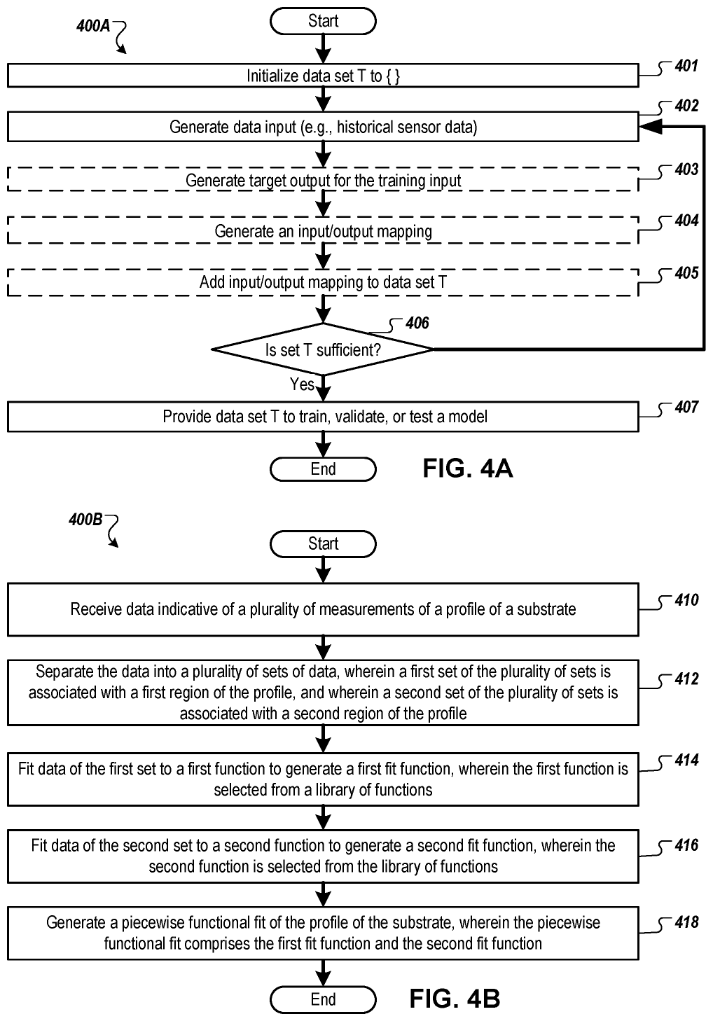

In some embodiments, data set generator 272B generates a data set (e.g., training set, validating set, testing set) that includes one or more data inputs 210B (e.g., training input, validating input, testing input). Data inputs 210B may also be referred to as “features,” “attributes,” or “information.” In some embodiments, data set generator 272B may provide the data set to the training engine 182, validating engine 184, or testing engine 186, where the data set is used to train, validate, or test the machine learning model (e.g., model 190 of FIG. 1). Some embodiments of generating a training set are further described with respect to FIG. 4A.

In some embodiments, data set generator 272B may generate a first data input corresponding to a first set of profile fit data 262A to train, validate, or test a first machine learning model and the data set generator 272B may generate a second data input corresponding to a second set of profile fit data 262B to train, validate, or test a second machine learning model.

Data inputs 210B to train, validate, or test a machine learning model may include information for a particular manufacturing chamber (e.g., for particular substrate manufacturing equipment). In some embodiments, data inputs 210B may include information for a specific type of manufacturing equipment, e.g., manufacturing equipment sharing specific characteristics. Data inputs 210B may include data associated with a device of a certain type, e.g., intended function, design, produced with a particular recipe, etc. Training a machine learning model based on a type of equipment, device, recipe, etc. may allow the trained model to generate clustering data useful for a number of substrates (e.g., for a number of different facilities, products, etc.).

In some embodiments, subsequent to generating a data set and training, validating, or testing a machine learning model using the data set, the model may be further trained, validated, or tested, or adjusted (e.g., adjusting weights or parameters associated with input data of the model, such as connection weights in a neural network).

FIG. 3 is a block diagram illustrating system 300 for generating output data (e.g., predictive data 168 of FIG. 1), according to some embodiments. In some embodiments, system 300 may be associated with generation and use of a model. System 300 may be associated with generation and use of a machine learning model. System 300 may be associated with generation and use of a physics-based model, statistical model, etc. Description of FIG. 3 is directed at a machine learning model, but similar techniques may be applicable to other types of models. System 300 may be used in conjunction with one or more additional models. In some embodiments, system 300 may be used in conjunction with a machine learning model to generate simulated substrates. System 300 may be used to determine a piecewise fit function of a profile of a substrate. System 300 may be used for analysis of fit parameters, e.g., clustering, outlier analysis, etc. System 300 may be used to predict substrate generation operations that may result in a target substrate profile. System 300 may be used in conjunction with a machine learning model with a different function than those listed, associated with a manufacturing system.

At block 310, system 300 (e.g., components of predictive system 110 of FIG. 1) performs data partitioning (e.g., via data set generator 172 of server machine 170 of FIG. 1) of data to be used in training, validating, and/or testing a machine learning model. In some embodiments, training data 364 includes historical data, such as historical metrology data, historical design rule data, historical classification data (e.g., classification of whether a product meets performance thresholds), historical substrate profile data, etc. Training data 364 may include historical sensor data. In some embodiments, training data 364 may include synthetic data, e.g., data associated with simulated substrates. Training data 364 may undergo data partitioning at block 310 to generate training set 302, validation set 304, and testing set 306. For example, the training set may be 60% of the training data, the validation set may be 20% of the training data, and the testing set may be 20% of the training data.

The generation of training set 302, validation set 304, and testing set 306 may be tailored for a particular application. For example, the training set may be 60% of the training data, the validation set may be 20% of the training data, and the testing set may be 20% of the training data. System 300 may generate a plurality of sets of features for each of the training set, the validation set, and the testing set. For example, if training data 364 includes sensor data and manufacturing parameters, including features derived from sensor data from 20 sensors (e.g., sensors 126 of FIG. 1) and 10 manufacturing parameters (e.g., manufacturing parameters that correspond to the same processing runs(s) as the sensor data from the 20 sensors), the sensor data may be divided into a first set of features including sensors 1-10 and a second set of features including sensors 11-20. The manufacturing parameters may also be divided into sets, for instance a first set of manufacturing parameters including parameters 1-5, and a second set of manufacturing parameters including parameters 6-10. Either target input, target output, both, or neither may be divided into sets. Multiple models may be trained on different sets of data.

At block 312, system 300 performs model training (e.g., via training engine 182 of FIG. 1) using training set 302. Training of a machine learning model and/or of a physics-based model (e.g., a digital twin) may be achieved in a supervised learning manner, which involves providing a training dataset including labeled inputs through the model, observing its outputs, defining an error (by measuring the difference between the outputs and the label values), and using techniques such as deep gradient descent and backpropagation to tune the weights of the model such that the error is minimized. In many applications, repeating this process across the many labeled inputs in the training dataset yields a model that can produce correct output when presented with inputs that are different than the ones present in the training dataset. In some embodiments, training of a machine learning model may be achieved in an unsupervised manner, e.g., labels or classifications may not be supplied during training. An unsupervised model may be configured to perform anomaly detection, result clustering, outlier analysis, etc.

For each training data item in the training dataset, the training data item may be input into the model (e.g., into the machine learning model). The model may then process the input training data item (e.g., sensor data associated with a processing procedure of a substrate, etc.) to generate an output. The output may include, for example, parameters associated with parameters of a fit of a profile of the substrate. The output may be compared to a label of the training data item (e.g., a fit of a profile of the substrate not generated by the model, a fit generated by a subject matter expert, etc.).

Processing logic may then compare the generated output (e.g., profile fit parameters) to the label (e.g., human-generated fit parameters) that was included in the training data item. Processing logic determines an error (i.e., a classification error) based on the differences between the output and the label(s). Processing logic adjusts one or more weights, biases, and/or other values of the model based on the error.

In the case of training a neural network, an error term or delta may be determined for each node in the artificial neural network. Based on this error, the artificial neural network adjusts one or more of its parameters for one or more of its nodes (the weights for one or more inputs of a node). Parameters may be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer. Accordingly, adjusting the parameters may include adjusting the weights assigned to each of the inputs for one or more neurons at one or more layers in the artificial neural network.

System 300 may train multiple models using multiple sets of features of the training set 302 (e.g., a first set of features of the training set 302, a second set of features of the training set 302, etc.). For example, system 300 may train a model to generate a first trained model using the first set of features in the training set (e.g., sensor data from sensors 1-10, metrology measurements 1-10, etc.) and to generate a second trained model using the second set of features in the training set (e.g., sensor data from sensors 11-20, metrology measurements 11-20, etc.). In some embodiments, the first trained model and the second trained model may be combined to generate a third trained model (e.g., which may be a better predictor or synthetic data generator than the first or the second trained model on its own). In some embodiments, sets of features used in comparing models may overlap (e.g., first set of features being sensor data from sensors 1-15 and second set of features being sensors 5-20). In some embodiments, hundreds of models may be generated including models with various permutations of features and combinations of models.

At block 314, system 300 performs model validation (e.g., via validation engine 184 of FIG. 1) using the validation set 304. The system 300 may validate each of the trained models using a corresponding set of features of the validation set 304. For example, system 300 may validate the first trained model using the first set of features in the validation set (e.g., sensor data from sensors 1-10 or metrology measurements 1-10) and the second trained model using the second set of features in the validation set (e.g., sensor data from sensors 11-20 or metrology measurements 11-20). In some embodiments, system 300 may validate hundreds of models (e.g., models with various permutations of features, combinations of models, etc.) generated at block 312. At block 314, system 300 may determine an accuracy of each of the one or more trained models (e.g., via model validation) and may determine whether one or more of the trained models has an accuracy that meets a threshold accuracy. Responsive to determining that none of the trained models has an accuracy that meets a threshold accuracy, flow returns to block 312 where the system 300 performs model training using different sets of features of the training set. Responsive to determining that one or more of the trained models has an accuracy that meets a threshold accuracy, flow continues to block 316. System 300 may discard the trained models that have an accuracy that is below the threshold accuracy (e.g., based on the validation set).

At block 316, system 300 performs model selection (e.g., via selection engine 185 of FIG. 1) to determine which of the one or more trained models that meet the threshold accuracy has the highest accuracy (e.g., the selected model 308, based on the validating of block 314). Responsive to determining that two or more of the trained models that meet the threshold accuracy have the same accuracy, flow may return to block 312 where the system 300 performs model training using further refined training sets corresponding to further refined sets of features for determining a trained model that has the highest accuracy.

At block 318, system 300 performs model testing (e.g., via testing engine 186 of FIG. 1) using testing set 306 to test selected model 308. System 300 may test, using the first set of features in the testing set (e.g., sensor data from sensors 1-10), the first trained model to determine the first trained model meets a threshold accuracy (e.g., based on the first set of features of the testing set 306). Responsive to accuracy of the selected model 308 not meeting the threshold accuracy (e.g., the selected model 308 is overly fit to the training set 302 and/or validation set 304 and is not applicable to other data sets such as the testing set 306), flow continues to block 312 where system 300 performs model training (e.g., retraining) using different training sets corresponding to different sets of features (e.g., sensor data from different sensors). Responsive to determining that selected model 308 has an accuracy that meets a threshold accuracy based on testing set 306, flow continues to block 320. In at least block 312, the model may learn patterns in the training data to make predictions or generate synthetic data, and in block 318, the system 300 may apply the model on the remaining data (e.g., testing set 306) to test the predictions or synthetic data generation.

At block 320, system 300 uses the trained model (e.g., selected model 308) to receive current data 322 (e.g., current sensor data 146 of FIG. 1) and determines (e.g., extracts), from the output of the trained model, output profile data 324 (e.g., profile data 162 of FIG. 1). A corrective action associated with the manufacturing equipment 124 of FIG. 1 may be performed in view of output profile data 324, such as updating a process recipe, scheduling or performing maintenance on manufacturing equipment and/or sensors, etc. In some embodiments, current data 322 may correspond to the same types of features in the historical data used to train the machine learning model. In some embodiments, current data 322 corresponds to a subset of the types of features in historical data that are used to train selected model 308 (e.g., a machine learning model may be trained using a number of sensor measurements, and configured to generate output based on a subset of sensor measurements).

In some embodiments, different data may be provided as current data 322 as model input, and different data than output profile data 324 may be received as model output. Models performing other functions, e.g., those described in connection with FIGS. 2A-B, may be used with analogous systems to system 300.

In some embodiments, the performance of a machine learning model trained, validated, and tested by system 300 may deteriorate. For example, a manufacturing system associated with the trained machine learning model may undergo a gradual change or a sudden change. A change in the manufacturing system may result in decreased performance of the trained machine learning model. A new model may be generated to replace the machine learning model with decreased performance. The new model may be generated by altering the old model by retraining, by generating a new model, etc. Retraining may be performed by introducing additional training data 346, e.g., to perform additional model training at block 312 including the retraining data.

In some embodiments, one or more of the acts 310-320 may occur in various orders and/or with other acts not presented and described herein. In some embodiments, one or more of acts 310-320 may not be performed. For example, in some embodiments, one or more of data partitioning of block 310, model validation of block 314, model selection of block 316, or model testing of block 318 may not be performed.

FIG. 3 depicts a system configured for training, validating, testing, and using one or more machine learning models. The machine learning models are configured to accept data as input (e.g., set points provided to manufacturing equipment, sensor data, metrology data, etc.) and provide data as output (e.g., predictive data, corrective action data, classification data, etc.). Partitioning, training, validating, selection, testing, and using blocks of system 300 may be executed similarly to train a second model, utilizing different types of data. Retraining may also be performed, utilizing current data 322 and/or additional training data 346.

FIGS. 4A-B are flow diagrams of methods 400A-B associated with training and utilizing machine learning models, according to certain embodiments. Methods 400A-B may be performed by processing logic that may include hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiment, methods 400A-B may be performed, in part, by predictive system 110. Method 400A may be performed, in part, by predictive system 110 (e.g., server machine 170 and data set generator 172 of FIG. 1, data set generators 272A-B of FIGS. 2A-B). Predictive system 110 may use method 400A to generate a data set to at least one of train, validate, or test a machine learning model, in accordance with embodiments of the disclosure. Method 400B may be performed by predictive server 112 (e.g., predictive component 114) and/or server machine 180 (e.g., training, validating, and testing operations may be performed by server machine 180). In some embodiments, a non-transitory machine-readable storage medium stores instructions that when executed by a processing device (e.g., of predictive system 110, of server machine 180, of predictive server 112, etc.) cause the processing device to perform one or more of methods 400A-B.

For simplicity of explanation, methods 400A-B are depicted and described as a series of operations. However, operations in accordance with this disclosure can occur in various orders and/or concurrently and with other operations not presented and described herein. Furthermore, not all illustrated operations may be performed to implement methods 400A-B in accordance with the disclosed subject matter. In addition, those skilled in the art will understand and appreciate that methods 400A-B could alternatively be represented as a series of interrelated states via a state diagram or events.

FIG. 4A is a flow diagram of a method 400A for generating a data set for a model, according to some embodiments. Method 400A may be used for generating a data set for a machine learning model, a physics-based model, etc. Referring to FIG. 4A, in some embodiments, at block 401 the processing logic implementing method 400A initializes a data set T (e.g., a data set for training, validating, or testing a model) to an empty set.

At block 402, processing logic generates first data input (e.g., first training input, first validating input) that may include one or more of sensor, manufacturing parameters, metrology data, substrate profile data, etc. In some embodiments, the first data input may include a first set of features for types of data and a second data input may include a second set of features for types of data (e.g., as described with respect to FIG. 3). Input data may include historical data and/or synthetic data in some embodiments.

In some embodiments, at block 403, processing logic optionally generates a first target output for one or more of the data inputs (e.g., first data input). In some embodiments, the input includes one or more indications of substrate processing (e.g., sensor data, manufacturing parameter data) and the target output includes properties of a simulated substrate. In some embodiments, the input includes data of a profile of a substrate and output includes a fit of the profile, such as a piecewise functional fit. In some embodiments, input includes profile fit parameters and output includes substrate generation conditions to generate a substrate matching the provided profile. In some embodiments, no target output is generated (e.g., an unsupervised machine learning model capable of grouping, clustering or finding correlations in input data, rather than requiring target output to be provided).

At block 404, processing logic optionally generates mapping data that is indicative of an input/output mapping. The input/output mapping (or mapping data) may refer to the data input (e.g., one or more of the data inputs described herein), the target output for the data input, and an association between the data input(s) and the target output. In some embodiments, such as in association with machine learning models where no target output is provided, block 404 may not be executed.

At block 405, processing logic adds the mapping data generated at block 404 to data set T, in some embodiments.

At block 406, processing logic branches based on whether data set T is sufficient for at least one of training, validating, and/or testing a machine learning model, such as model 190 of FIG. 1. If so, execution proceeds to block 407, otherwise, execution continues back at block 402. It should be noted that in some embodiments, the sufficiency of data set T may be determined based on the number of inputs, mapped in some embodiments to outputs, in the data set, while in some other embodiments, the sufficiency of data set T may be determined based on one or more other criteria (e.g., a measure of diversity of the data examples, accuracy, etc.) in addition to, or instead of, the number of inputs.

At block 407, processing logic provides data set T (e.g., to server machine 180) to train, validate, and/or test machine learning model 190. In some embodiments, data set T is a training set and is provided to training engine 182 of server machine 180 to perform the training. In some embodiments, data set T is a validation set and is provided to validation engine 184 of server machine 180 to perform the validating. In some embodiments, data set T is a testing set and is provided to testing engine 186 of server machine 180 to perform the testing. In the case of a neural network, for example, input values of a given input/output mapping (e.g., numerical values associated with data inputs 210A) are input to the neural network, and output values (e.g., numerical values associated with target outputs 220A) of the input/output mapping are stored in the output nodes of the neural network. The connection weights in the neural network are then adjusted in accordance with a learning algorithm (e.g., back propagation, etc.), and the procedure is repeated for the other input/output mappings in data set T. After block 407, a model (e.g., model 190) can be at least one of trained using training engine 182 of server machine 180, validated using validating engine 184 of server machine 180, or tested using testing engine 186 of server machine 180. The trained model may be implemented by predictive component 114 (of predictive server 112) to generate predictive data 168 for performing signal processing, to generate profile data 162, or for performing a corrective action associated with manufacturing equipment 124.

FIG. 4B is a flow diagram of a method 400B for generating a profile piecewise functional fit, according to some embodiments. At block 410 of method 400B, processing logic receives data indicative of a plurality of measurements of a profile of a substrate. The substrate may be a physical substrate, e.g., manufactured by manufacturing equipment 124 of FIG. 1, the profile measured by metrology equipment 128, etc. The substrate may be a simulated substrate, e.g., measurements may be generated by a machine learning model, a physics-based model, etc. The substrate may be a semiconductor device. The substrate may be a memory device, e.g., a semiconductor memory device.

Generating a simulated substrate may include providing inputs to a model. Generating a simulated substrate may include providing one or more machine learning inputs to a machine learning model. Generating a simulated substrate may include providing one or more simulation inputs to a physics-based model. Generating a simulated substrate may include obtaining, as output from the model, one or more indications of properties of the simulated substrate. The indications of properties of the simulated substrate may include values associated with a profile of the substrate, e.g., measurements of geometry of the simulated substrate. From the indications of properties of the substrate, processing logic may perform data processing to determine measurements of a profile of the substrate, e.g., in a format associated with measuring a profile of a physical substrate, in a format accepted as input by a model, etc.

At block 412, processing logic separates the data indicative of the plurality of measurements into a plurality of sets of data. A first set of the plurality of sets is associated with a first region of the profile. A second set of the plurality of sets is associated with a second region of the profile. In some embodiments, the boundary between the sets may be a boundary between regions of the profile described by different fit functions.

At block 414, processing logic fits data of the first set to a first function to generate a first fit function. The first function may be selected from a library of functions. Generating the first fit function may include determining one or more parameters of the fit function. A procedure may be used to generate the fit function, e.g., to minimize an error function between the fit and the measurements of the region of the profile. The library of functions may include polynomial functions (e.g., zeroth-order polynomials or constants, first-order linear polynomials, second-order quadratic polynomials, higher-order polynomials, etc.), exponential functions, logarithmic functions, and/or any other type of functions that may be applicable to a substrate profile. The library of functions may include combinations of functions, e.g., additive combinations of functions, multiplicative combinations of functions, etc. The fit procedure may select values for coefficients and/or other parameters, e.g., to minimize an error function between the fit and the data points associated with the substrate profile. In some embodiments, a user selects the first function from a library of functions. In some embodiments, processing logic selects the first function from a library of functions.

At block 416, processing logic fits data of the second set to a second function to generate a second fit function. The second function may be selected from a library of functions, e.g., the same library as the first function is selected from. In some embodiments, the first region of the profile is adjacent to the second region of the profile. Generating the first and second fit functions may include accounting for one or more boundary conditions, e.g., constraints enforced at the boundary between the two regions. For example, a continuity constraint may be enforced (the value of the first fit function as the function approaches the boundary is equal to the value of the second fit functions as the function approaches the boundary from the second region). A smoothness constraint may be enforced (the value of the first derivative of the first fit function is equal to the value of the first derivative of the second fit function as the function approaches the boundary). Higher order constraints may be enforced, e.g., a concavity constraint related to the second derivatives of the first and second fit functions may be enforced. Enforcing constraints may generate a more realistic (e.g., physically plausible) fit model. Enforcing constraints may cause generation of a better statistical fit by removing free variables (e.g., degrees of freedom) from the fitting procedure.

At block 418, processing logic generates a piecewise functional fit of the profile of the substrate. The piecewise functional fit includes the first fit function and the second fit function.

In some embodiments, further operations may be performed. For example, a plurality of piecewise functional fits (e.g., parameters of the fits) may be obtained by processing logic. The processing logic may provide the plurality of piecewise functional fits to a machine learning model. The processing logic may receive as output from the model data indicative of an analysis of the parameters. For example, the model may be configured to perform clustering analysis, outlier analysis, etc., on the supplied fit parameters.

In some embodiments, the piecewise profile fit may be utilized for further learning. For example, parameters of the fit may be utilized to generate an understanding of the effect of substrate generation inputs (e.g., processing conditions, simulation conditions, etc.) on profile shape. Parameters of the piecewise profile fit function may have physical meaning. A relationship between an input parameter and a physical result may improve system learning, improve recipe generation, improve anomaly detection, improve corrective action recommendations, etc. For example, processing logic may provide, to a model, one or more input conditions associated with generating a substrate. Processing logic may provide, to the model, a piecewise functional fit. Processing logic may obtain, from the model, an indication of an effect of a first input condition of the one or more input conditions on a first parameter of the piecewise functional fit.

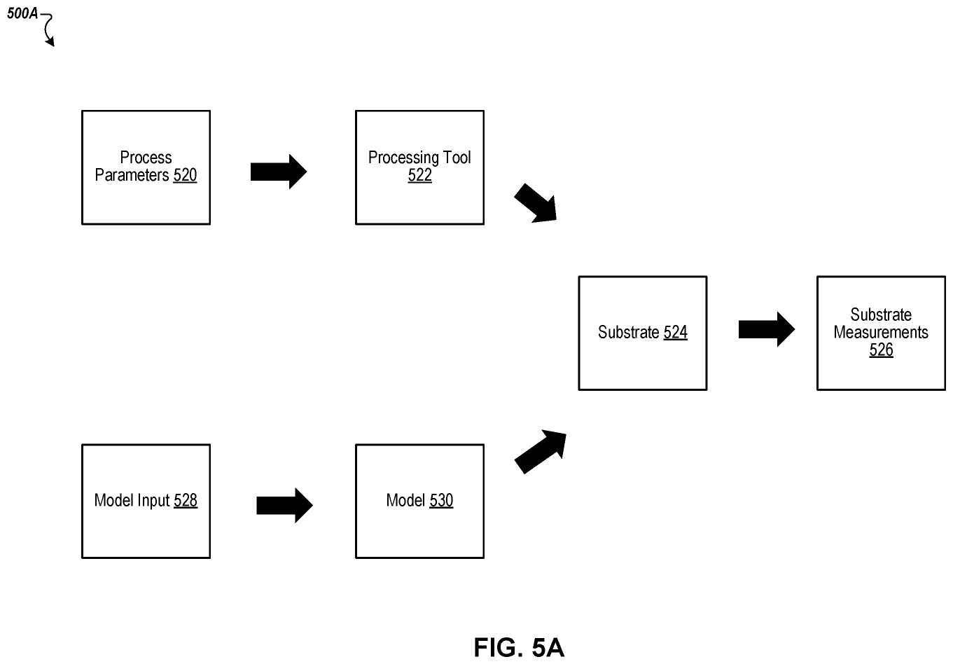

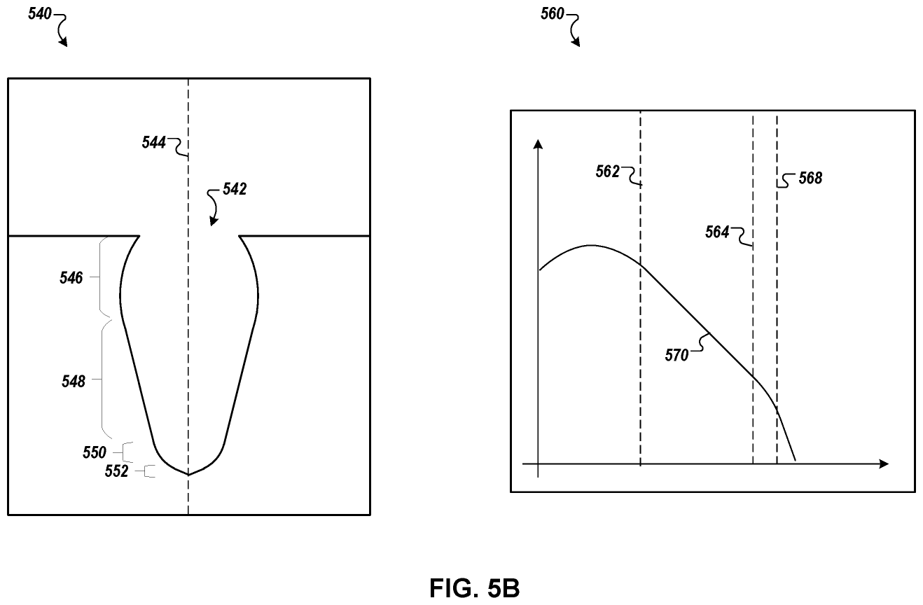

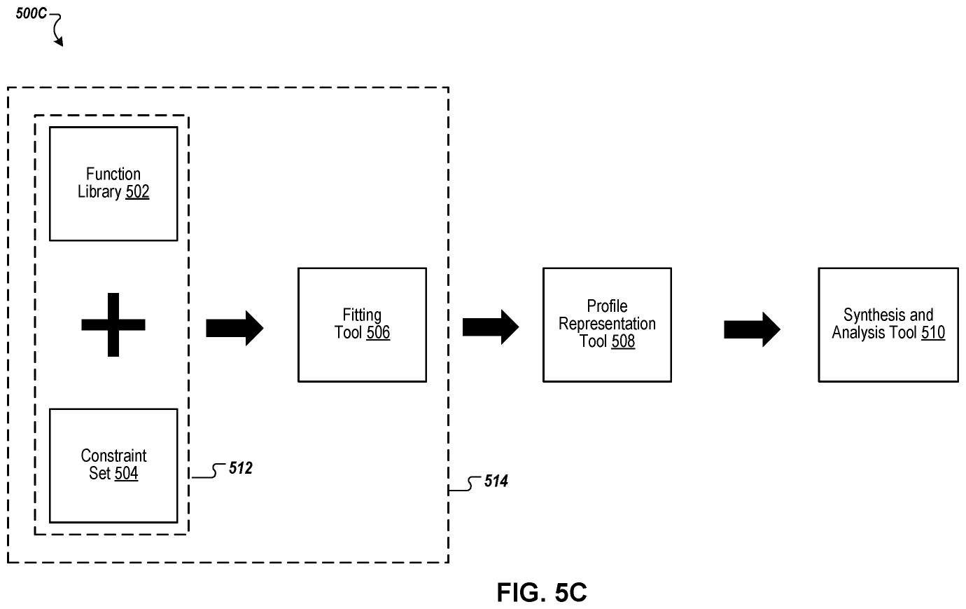

FIG. 5A depicts substrate measurement generation system 500A, according to some embodiments. Substrate generation system 500A includes generation of physical and simulated substrates. Physical and simulated substrates may be used together, e.g., to increase accuracy of a substrate generation system over use of simulated substrates alone, to decrease cost of a substrate generation system compared to use of physical substrate generation alone, etc.

In generating a physical substrate, process parameters 520 are generated. Process parameters 520 may be provided to a processing device (e.g., a controller of a substrate manufacturing system). Process parameters 520 may be input by a user, may be generated by a model, etc. Process parameters 520 may be related to manufacturing parameters, e.g., stored in data store 140 of FIG. 1.

Process parameters are provided to processing tool 522. Processing tool 522 may be or comprise manufacturing equipment 124 of FIG. 1. Processing tool 522 may include one or more processing chambers. Processing tool 522 may be configured to perform processing operations on one or more substrates. Processing operations may include etch operations, deposition operations, anneal operations, etc. Processing tool 522 may generate a physical substrate, substrate 524.

In generating a simulated substrate, model input 528 is obtained by a processing device. Model input 528 may include any input provided to a model configured to generate a simulated substrate as output. Model input 528 may include sensor data. Model input 528 may include manufacturing parameters. Model input 528 may include other simulation input.

Model inputs are provided to model 530. Model 530 may be a physics-based model, a machine learning model, a combination thereof, etc. Model 530 may generate a simulated substrate, substrate 524, in view of the model input. Simulated substrates may include data indicative of properties of the substrate, e.g., geometry of the substrate.

Substrate 524 is provided to a system for generating substrate measurements 526. Substrate 524 may be provided to a system for generating measurements of a profile of the substrate, e.g., a critical dimension (CD) profile of the substrate. A physical substrate 524 may be provided to metrology tools to perform substrate measurements. A simulated substrate may be provided to a digital tool to have relevant measurements (e.g., CD profile of the substrate) extracted from the data provided by model 530.

FIG. 5B depicts a substrate 540 and a piecewise functional fit 560 of the substrate profile, according to some embodiments. Substrate 540 includes a depression 542, e.g., a hole, a trough, etc. A profile of substrate 540 may describe the shape of the depression, e.g., the shape generated while performing one or more etch operations on the substrate. A profile of substrate 540 may describe a CD of substrate 540. A profile of substrate 540 may be a measure of how wide depression 542 is as a function of depth, e.g., the profile may be an indication of distance from sidewall to sidewall perpendicular to centerline 544. The profile may comprise a number of measurements of width of the depression 542, taken at various depths of depression 542, perpendicular to various positions of centerline 544, etc.

A profile of substrate 540 may be considered to be comprised of a number of regions, e.g., regions 546-552. Some regions of the profile may be curved (e.g., regions 546 and 550), some regions may be substantially straight (e.g., regions 548 and 552), etc. Generating a fit function describing a substrate profile may be improved by generating a piecewise function, e.g., including different fit functions directed at fitting portions that are shaped such that the portions of the profile may be accurately described by the function.

Functional fit 560 depicts a fit of the profile of the substrate 540. Functional fit 560 depicts the piecewise profile functional fit (e.g., CD as a function of depth). The fit is displayed as profile fit 570. The plot of the functional fit 560 includes boundaries 562, 564, and 568. The boundaries 562-568 correlate to the boundaries between regions 546-552 of substrate 540.

In some embodiments, a user may select functions relevant to regions of the functional fit. For example, a user may be presented with a profile (e.g., data points representing the profile of substrate 540), and may select a series of functions that may be utilized to fit the profile. For example, a user may choose a quadratic function for the region before boundary 562, a linear function for the region before boundary 564, a quadratic function for the region before boundary 568, and a linear function for the remainder of the profile. A processing device may determine the placement of boundaries 562-568 (e.g., to minimize an error function), parameters of the fit functions, etc.

In some embodiments, a user may select constraints (e.g., boundary conditions) to be followed by the piecewise functional fit. In some embodiments, a user may select one set of constraints to be used for each boundary (e.g., boundaries 562-568). In some embodiments, a user selects sets of constraints individually for individual boundaries (e.g., boundary conditions associated with boundary 562 may be different than boundary conditions associated with boundary 564).

In some embodiments, a processing device may select functions to use to fit regions of a profile. A processing device may utilize a machine learning model to select functions to use for fitting a profile (e.g., configured to separate a profile into fit regions). A processing device may utilize a physics-based model to select functions to use for fitting a profile. A processing device may utilize a fit model (e.g., may select functions for fitting that generate fits with minimized error functions, minimized functions of merit, etc.). In some embodiments, a hybrid system may be utilized, e.g., a user may select a subset of a library of functions for consideration, and a processing device may determine which of the subset to use in the fit.

In some embodiments, a processing device selects boundary constraints to be followed by the piecewise functional fit. A processing device may select boundary conditions to minimize an error function, achieve a target number of free variables, minimize another functions of merit, etc. In some embodiments, a hybrid system may be utilized, e.g., a user may select a subset of a list of boundary conditions that may be enforced, and the processing device may further refine the selection of boundary conditions to apply at each boundary.

FIG. 5C is a flow diagram of system components of a system 500C for generating and utilizing a piecewise functional fit of a substrate profile, according to some embodiments.

System 500C includes function library 502. Function library 502 may include a set of functions that may be fit to various portions of substrate profile data corresponding to physical regions of the substrate profile. Function library 502 may include, for example, polynomial functions (e.g., constants or zeroth-order polynomials, linear or first-order polynomials, quadratic or second-order polynomials, cubic or third-order polynomials, higher order polynomials, etc.), exponential functions (e.g., functions of the form y=A^{Bx}), logarithmic functions, distribution functions (e.g., Gaussian, Lorentzian, Voigt, etc.), trigonometric functions (e.g., sine, cosine, hyperbolic sine, etc.), logistic functions, etc. Function library 502 may allow and/or include combinations of functions, e.g., additive combinations (e.g., a polynomial added to an exponential), multiplicative combinations (e.g., an exponential multiplied by a logarithm), etc. In some embodiments, a subset of library 502 may be utilized, e.g., a user selection may limit the number and/or types of functions available for fitting the profile, available for fitting one or more portions of the profile, etc. In some embodiments, a user may select the one or more functions from function library 502 to be used in fitting the profile.

System 500C further includes constraint set 504. Constraint set 504 may include one or more constraints, e.g., for use in fitting the piecewise functional fit (e.g., for use by fitting tool 506). Constraints may include conditions enforced at boundaries of the piecewise functional fit (e.g., boundaries between regions fit by different functions, boundaries between regions with different shapes, etc.). Constraints may include continuity of functions across a boundary and/or their derivatives, within a threshold value. For example, a constraint may enforce continuity of the piecewise functional fit across a boundary, a second constraint may enforce smoothness (e.g., continuity of the first derivatives) of the fit across the boundary, a third constraint may enforce smooth curvature (e.g., continuity of the second derivatives) of the fit across the boundary, etc. Constraints may be different for different boundaries of the piecewise functional fit. Constraints may be selected by a user or selected (e.g., optimized) by a processing device. Constraints may be used to reduce the space of the fit (e.g., to reduce the number of floating parameters, the number of free variables, etc.).

In some embodiments, elements of group 512 may be selected by a user. For example, a user may select functions from a function library to represent various portions of the profile, and select boundary conditions to be enforced at each boundary. The user selection may be passed to fitting tool 506.

Fitting tool 506 may generate the piecewise functional fit of the substrate profile. Fitting tool 506 may be configured to reduce an error function, e.g., a least squares error, an error function that penalizes nonzero coefficients to reduce a number of terms, etc. In some embodiments, elements of group 514 may be performed by a processing device, e.g., a processing device may select the boundary points between regions of the profile, the functions to use to fit the regions, and the constraints to utilize (potentially subject to one or more user selections). The processing device may select functions, boundaries, values of parameters, etc., to minimize an error of the fit.

The piecewise functional fit may be provided to profile representation tool 508. Profile representation tool may be utilized to visualize, analyze, etc., the piecewise functional fit of the substrate profile. The piecewise functional fit may further be provided to synthesis and analysis tool 510. Synthesis and analysis tool may assist a user in designing an experiment to match a profile, in designing an experiment to alter one or more features of a profile, in mining for clustering of parameter values, chosen functions, or other aspects of one or more piecewise functional fits, in correlating substrate generating inputs to functional fit outputs, in correlating parameters of the piecewise functional fits, etc. Synthesis and analysis tool 510 may be utilized to extract various relationships between data associated with the piecewise functional fit. For example, synthesis and analysis tool 510 may be utilized to generate plots linking input and output parameters (e.g., scatter plots of one parameter vs. a model input).

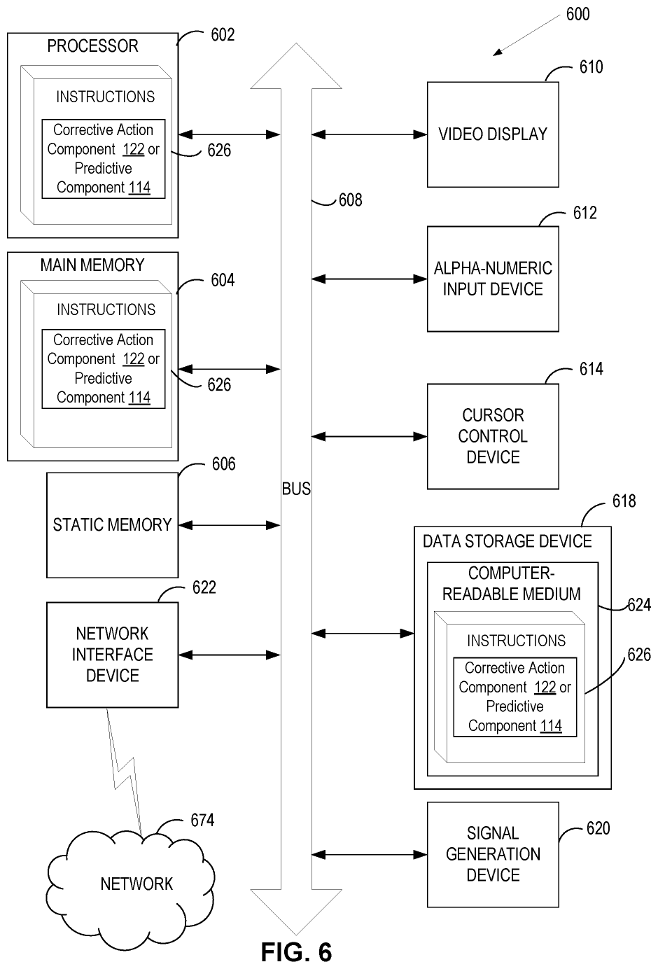

FIG. 6 is a block diagram illustrating a computer system 600, according to some embodiments. In some embodiments, computer system 600 may be connected (e.g., via a network, such as a Local Area Network (LAN), an intranet, an extranet, or the Internet) to other computer systems. Computer system 600 may operate in the capacity of a server or a client computer in a client-server environment, or as a peer computer in a peer-to-peer or distributed network environment. Computer system 600 may be provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 600 may include a processing device 602, a volatile memory 604 (e.g., Random Access Memory (RAM)), a non-volatile memory 606 (e.g., Read-Only Memory (ROM) or Electrically-Erasable Programmable ROM (EEPROM)), and a data storage device 618, which may communicate with each other via a bus 608.

Processing device 602 may be provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

Computer system 600 may further include a network interface device 622 (e.g., coupled to network 674). Computer system 600 also may include a video display unit 610 (e.g., an LCD), an alphanumeric input device 612 (e.g., a keyboard), a cursor control device 614 (e.g., a mouse), and a signal generation device 620.

In some embodiments, data storage device 618 may include a non-transitory computer-readable storage medium 624 (e.g., non-transitory machine-readable medium) on which may store instructions 626 encoding any one or more of the methods or functions described herein, including instructions encoding components of FIG. 1 (e.g., predictive component 114, corrective action component 122, model 190, etc.) and for implementing methods described herein.

Instructions 626 may also reside, completely or partially, within volatile memory 604 and/or within processing device 602 during execution thereof by computer system 600, hence, volatile memory 604 and processing device 602 may also constitute machine-readable storage media.

While computer-readable storage medium 624 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “performing,” “providing,” “obtaining,” “causing,” “accessing,” “determining,” “adding,” “using,” “training,” “reducing,” “generating,” “correcting,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may include a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and embodiments, it will be recognized that the present disclosure is not limited to the examples and embodiments described. The scope of the disclosure should be determined with reference to the following claims, along with the full scope of equivalents to which the claims are entitled.

What is claimed is:

1. A method, comprising:
receiving, by a processing device, data indicative of a plurality of measurements of a profile of a substrate;
separating, by the processing device, the data indicative of the plurality of measurements into a plurality of sets of data, wherein a first set of the plurality of sets is associated with a first region of the profile, and wherein a second set of the plurality of sets is associated with a second region of the profile;
fitting data of the first set to a first function to generate a first fit function, wherein the first function is selected from a library of functions;
fitting data of the second set to a second function to generate a second fit function, wherein the second function is selected from the library of functions, and wherein the second function is different from the first function; and
generating a piecewise functional fit of the profile of the substrate, wherein the piecewise functional fit comprises the first fit function and the second fit function.

2. The method of claim 1, wherein generating the piecewise functional fit of the profile comprises:
applying one or more constraints to data points associated with a boundary between the first region and the second region.

3. The method of claim 2, wherein the constraints are selected from a group comprising:
continuity of the piecewise functional fit across the boundary;
continuity of a first derivative of the piecewise functional fit across the boundary; and
continuity of a second derivative of the piecewise functional fit across boundary.

4. The method of claim 1, wherein the library of functions comprises at least one of:
zeroth-order polynomials;
first-order polynomials;
second-order polynomials;
exponential functions; or
logarithmic functions.

5. The method of claim 1, wherein the plurality of measurements of the profile of the substrate are associated with a simulated substrate, and wherein generating the simulated substrate comprises:
providing one or more simulation inputs to a physics-based model;
receiving, from the physics-based model, data indicative of the simulated substrate; and
extracting, from the data indicative of the simulated substrate, the plurality of measurements of the profile of the substrate.

6. The method of claim 1, wherein the plurality of measurements of the profile of the substrate are associated with a simulated substrate, wherein generating the simulated substrate comprises:
providing one or more machine learning inputs to a machine learning model;
receiving, from the machine learning model, data indicative of geometry of the simulated substrate; and
extracting, from the data indicative of geometry of the simulated substrate, the plurality of measurements of the profile of the substrate.

7. The method of claim 1, wherein the substrate comprises a semiconductor memory device.

8. The method of claim 1, further comprising:
receiving a plurality of piecewise functional fits, wherein the plurality of piecewise functional fits are associated with a plurality of profiles of a plurality of substrates;
providing the plurality of piecewise functional fits and the piecewise functional fit to a machine learning model; and
receiving, from the machine learning model, data indicative of clustering of fit parameters of the plurality of piecewise functional fits and the piecewise functional fit.

9. The method of claim 1, further comprising:
receiving a user selection of the first function; and
receiving a user selection of the second function.

10. The method of claim 1, further comprising:
selecting, by the processing device, the first function from the library of functions; and
selecting, by the processing device, the second function from the library of functions.

11. The method of claim 1, further comprising:
providing, to a model, one or more input conditions associated with generating the substrate;
providing, to the model, the piecewise functional fit;
receiving, from the model, an indication of an effect of a first input condition of the one or more input conditions on a first parameter of the piecewise functional fit.

12. A non-transitory machine readable storage medium storing instructions which, when executed, cause a processing device to perform operations comprising:
receiving data indicative of a plurality of measurements of a profile of a substrate;
separating the data indicative of the plurality of measurements into a plurality of sets of data, wherein a first set of the plurality of sets is associated with a first region of the profile, and wherein a second set of the plurality of sets is associated with a second region of the profile;
fitting data of the first set to a first function to generate a first fit function, wherein the first function is selected from a library of functions;
fitting data of the second set to a second function to generate a second fit function, wherein the second function is selected from the library of functions, and wherein the second function is different from the first function; and
generating a piecewise functional fit of the profile of the substrate, wherein the piecewise functional fit comprises the first fit function and the second fit function.

13. The non-transitory machine readable storage medium of claim 12, wherein generating the piecewise functional fit of the profile comprises applying one or more constraints to data points associated with a boundary between the first region and the second region.

14. The non-transitory machine readable storage medium of claim 12, wherein the library of functions comprises at least one of:
zeroth-order polynomials;
first-order polynomials;
second-order polynomials;
exponential functions; or
logarithmic functions.

15. The non-transitory machine readable storage medium of claim 12, wherein the substrate comprises a semiconductor memory device.

16. The non-transitory machine readable storage medium of claim 12, wherein the operations further comprise:
providing, to a model, one or more input conditions associated with generating the substrate;
providing, to the model, the piecewise functional fit;
receiving, from the model, an indication of an effect of a first input condition of the one or more input conditions on a first parameter of the piecewise functional fit.

17. A system, comprising memory and a processing device coupled to the memory, wherein the processing device is configured to:
receive data indicative of a plurality of measurements of a profile of a substrate;
separate the data indicative of the plurality of measurements into a plurality of sets of data, wherein a first set of the plurality of sets is associated with a first region of the profile, and wherein a second set of the plurality of sets is associated with a second region of the profile;
fit data of the first set to a first function to generate a first fit function, wherein the first function is selected from a library of functions;
fit data of the second set to a second function to generate a second fit function, wherein the second function is selected from the library of functions, and wherein the second function is different from the first function; and
generate a piecewise functional fit of the profile of the substrate, wherein the piecewise functional fit comprises the first fit function and the second fit function.

18. The system of claim 17, wherein generating the piecewise functional fit of the profile comprises applying one or more constraints to data points associated with a boundary between the first region and the second region.

19. The system of claim 18, wherein the constraints are selected from a group comprising:
continuity of the piecewise functional fit across the boundary;
continuity of a first derivative of the piecewise functional fit across the boundary; and
continuity of a second derivative of the piecewise functional fit across boundary.

20. The system of claim 17, wherein the processing device is further configured to:
select the first function from the library of functions; and
select the second function from the library of functions.
